(19) United States
(12) Patent Application Publication
(10) Pub. No.: US 2011/0158067 A1
(43) Pub. Date: Jun. 30, 2011

(54) Recording/reproducing device and method for controlling same

(75) Inventors: Yasuhiro Harada, Osaka (JP); Shigemi Maeda, Osaka (JP); Tetsuya Okumura, Osaka (JP); Noboru Iwata, Osaka (JP); Tazuko Kitazawa, Osaka (JP); Toshihiko Sakai, Osaka (JP); Hirohisa Yamada, Osaka (JP)

(73) Assignee: Sharp Kabushiki Kaisha, Osaka (JP)

(21) Appl. No.: 12/930,135

(22) Filed: Dec. 29, 2010

(30) Foreign Application Priority Data
Dec. 29, 2009 (JP) JP299203/2009

(51) Int. Cl. G11B 20/00

(52) U.S. Cl. 369/47.15; G9B/20

(57) ABSTRACT

A recording/reproducing device includes: a data comparing section which compares, at the time of ejection of an optical disc, recorded information recorded on a ROM layer of the optical disc and relevant information (e.g., additional data) which is stored in the recording/reproducing device and which is related to registered information (e.g., content) recorded on an RE layer of the optical disc; and a data selecting section which selects, based on a result of the comparison by the data comparing section, relevant information for recording to be recorded on the ROM layer of the optical disc from among the relevant information.

This Nonprovisional application claims priority under 35 U.S.C. §119(a) on Patent Application No. 2009-299203 filed in Japan on Dec. 29, 2009, the entire contents of which are hereby incorporated by reference.

### TECHNICAL FIELD

The present invention relates to an information recording medium having a plurality of information recording regions on which various kinds of information are recorded, and a recording/reproducing device that is capable of recording information on the information recording medium or reading out information from the information recording medium.

### BACKGROUND ART

Conventional recording/reproducing devices such as a recorder with a built-in optical disc device represented by a BD (Blu-ray Disc) recorder and a DVD (Digital Versatile Disc) recorder and a video camera with a built-in optical disc device are capable of storing captured image data and program data in a storage device such as a built-in HDD (Hard Disc Drive) and then duplicating (dubbing or copying) such data to an information recording medium such as the optical disc.

However, in such conventional recording/reproducing devices, for example in a case where captured image data is copied to an optical disc, a user must carry out the copying operation during intervals between shooting operations. Further, for example in a case where program data is copied to an optical disc, a user must cause a screen to display the program data before carrying out the copying operation since the user needs to select the required program from among a large number of program data stored in an HDD. As above, a conventional recording/reproducing device forces a user who copies data stored in an HDD to an optical disc to carry out complicated operations.

In contrast to this, Patent Literature 1 for example discloses a technique for automatically recording captured image data or program data stored in an HDD on an optical disc without forcing a user to carry out complicated operations.

A recording/reproducing device disclosed in Patent Literature 1 identifies a type of an inserted optical disc when the optical disc is inserted. In a case where it is determined that the inserted optical disc is a recordable optical disc such as a write-once type optical disc or a rewritable optical disc, the recording/reproducing device can almost automatically copy captured image data or program data stored in a built-in HDD to the optical disc during a period in which operations such as shooting, recording, and reproducing are not carried out in the recording/reproducing device.

### CITATION LIST

### Patent Literature 1

Japanese Patent Application Publication, Tokukai, No. 2006-294105 A (Publication Date: Oct. 26, 2006)

### SUMMARY OF INVENTION

### Technical Problem

However, the recording/reproducing device disclosed in Patent Literature 1 only assumes captured image data and program data as data to be stored in a recordable medium. In a recording/reproducing device, not only captured image data and program data but also data acquired via a network are stored. However, the recording/reproducing device disclosed in Patent Literature 1 does not assume that such data acquired via a network is stored.

Examples of the data acquired via a network include data acquired with the use of a BD-Live function (function of downloading and acquiring, via a network, additional data (relevant data), such as additional subtitles and additional movie, related to a reproduced content (recorded data) recorded on a BD-ROM that is being reproduced) employed in BD recorders and BD players. It should be noted that the present BD-Live function requires a user to first reproduce a BD-ROM in order to acquire and reproduce additional data.

In Patent Literature 1, it is assumed that such additional data acquired via a network is stored as follows.

First, a reproduction-only medium (BD-ROM) in which record data for acquiring additional data is stored is inserted into a recording/reproducing device. Thus, the additional data is acquired. The relevant data thus acquired is stored in a storage device such as an HDD provided in the recording/reproducing device. In this state, the reproduction-only medium is still inserted into the recording/reproducing device. Even the recording/reproducing device of Patent Literature 1 which is capable of automatically storing data cannot store the relevant data in a medium side unless the reproduction-only medium is replaced by a recordable medium.

That is, according to the recording/reproducing device disclosed in Patent Literature 1, in order to store acquired relevant data in a medium side, it is necessary to carry out medium exchange, i.e., to take out a reproduction-only medium and then insert another medium that is recordable. Specifically, a reproduction-only medium (reproduction-only optical disc) is removed, a recordable medium (recordable optical disc) is inserted into the recording/reproducing device, and then relevant data is automatically recorded on the recordable optical disc. As has been described, in order to acquire and store the relevant data, it is necessary for a user to go into the trouble of taking out a reproduction-only optical disc on which record data is recorded and then inserting a recordable optical disc. This is very troublesome for the user.

Moreover, according to the recording/reproducing device, relevant data is acquired by reproducing a reproduction-only optical disc, and the relevant data thus acquired is stored in a recordable optical disc that is different from the reproduction-only optical disc. As a result, a user must manage at least two discs, i.e., the reproduction-only disc and the recordable optical disc on which the relevant data has been recorded. Since the number of discs which must be managed increases, management of the discs becomes very troublesome.

Moreover, the relevant data is utilized with the use of record data recorded on the reproduction-only optical disc. According to the recording/reproducing device of Patent Literature 1, it is therefore necessary for a user to go into the trouble of (i) inserting the recordable optical disc in which the relevant data is stored in order that the relevant data is recorded on a storage device such as an HDD provided in the recording/reproducing device, and then (ii) inserting the reproduction-only medium in which data for utilizing the relevant data is stored.

Moreover, the recording/reproducing device of Patent Literature 1 does not assume that record data recorded on the reproduction-only medium and relevant data related to the record data are recorded on a single optical disc. This is because the recording/reproducing device of Patent Literature 1 assumes that only a recordable medium or a reproduction-only medium is used, and therefore inevitably requires medium exchange.

Moreover, since the recording/reproducing device of Patent Literature 1 does not assume that record data and relevant data related to the record data are recorded on a single optical disc, a data recording method for avoiding a trouble of a user who wants the record data and the relevant data to be recorded on a single optical disc is not naturally assumed.

The present invention was attained in order to solve the above problems, and an object of the present invention is to provide (i) a recording/reproducing device which records, on an information recording medium, relevant information related to registered information, such as a content, which is recorded in advance on the information recording medium, thereby allowing easy management of the relevant information without bothering a user and (ii) a method for controlling the recording/reproducing device.

### Solution to Problem

In order to attain the above object, a recording/reproducing device of the present invention which records/reproduces information on/from an information recording medium which includes a first information recording layer which only allows information to be read out and a second information recording layer which allows information to be additionally recorded or to be rewritten, includes: comparing means for comparing, at a time of ejection of the information recording medium, recorded information which is recorded on the second information recording layer and recorded relevant information which is stored in the recording/reproducing device and which is related to registered information recorded on the first information recording layer; and selecting means for selecting, based on a result of the comparison by the comparing means, relevant information for recording, which is information to be recorded on the second information recording layer, from among the recorded relevant information.

In order to attain the above object, a method of the present invention for controlling a recording/reproducing device which records/reproduces information on/from an information recording medium which includes a first information recording layer which only allows information to be read out and a second information recording layer which allows information to be additionally recorded or to be rewritten, includes the steps of: (a) comparing, at a time of ejection of the information recording medium, recorded information which is recorded on the second information recording layer and recorded relevant information which is stored in the recording/reproducing device and which is related to registered information recorded on the first information recording layer; and (b) selecting, based on a result of the comparison in the step (a), relevant information for recording, which is information to be recorded on the second information recording layer, from among the recorded relevant information.

According to the arrangement, the comparing means (comparing step) compares, at the time of ejection of the information recording medium including the first information recording layer and the second information recording layer, recorded information which is recorded on the second information recording layer and recorded relevant information which is stored in the recording/reproducing device, and the selecting means (selecting step) selects, based on a result of the comparison, relevant information for recording from among the recorded relevant information, the relevant information for recording being information to be recorded on the second information recording layer of the information recording medium in which registered information is recorded on the first information recording layer.

The recording/reproducing device therefore can eliminate the need for user's operations (selection of relevant information for recording, exchange of information recording media etc.) which have been conventionally required in a case where the registered information and the information (relevant information for recording) related to the registered information are recorded on different information recording media. This can improve convenience for a user.

Moreover, since only recorded relevant information which is not recorded on the information recording medium can be selected as relevant information for recording, it is possible to shorten a time required for recording of relevant information for recording and to effectively utilize a storage capacity of the information recording medium.

Moreover, the relevant information for recording to be recorded on the information recording medium is selected when use of the inserted information recording medium in the recording/reproducing device is finished (i.e., when the information recording medium is ejected). This eliminates the need for carrying out processes such as (i) selecting the relevant information for recording many times during intervals between various operations in the recording/reproducing device such as a reproducing operation or (ii) selecting the relevant information for recording by temporarily stopping these operations. That is, it is possible to collectively select relevant information for recording to be recorded on the second information recording layer while maintaining processing efficiency of the recording/reproducing device.

Therefore, the recording/reproducing device (the method for controlling the recording/reproducing device) of the present invention produces an effect that it is possible to easily manage information related to registered information recorded in advance on an information recording medium without bothering a user by causing the information to be recorded on the information recording medium.

Note that the registered information refers to information that is recorded in advance on an information recording medium (first information recording layer). Examples of the registered information include a content and software. Note also that the recorded information refers to information that is recorded in advance on the second information recording layer or information that has been recorded on the second information recording layer by the recording/reproducing device.

In order to attain the above object, a recording/reproducing device of the present invention which records/reproduces information on/from an information recording medium which includes a first information recording layer which only allows information to be read out and a second information recording layer which allows information to be additionally recorded or to be rewritten, includes: comparing means for comparing, at a time of ejection of the information recording medium, (i) recorded relevant information which is recorded on the second information recording layer as information related to registered information recorded on the first information recording layer and (ii) record management information indicative of attribute information of recorded relevant information which is present in the second information recording layer from a time of insertion of the information recording medium; and selecting means for selecting, based on a result of the comparison by the comparing means, relevant information for recording, which is information to be recorded on the second information recording layer, from among the recorded relevant information which is recorded on the second information recording layer as the information related to the registered information recorded on the first information recording layer.

In order to attain the above object, a method of the present invention for controlling a recording/reproducing device which records/reproduces information on/from an information recording medium which includes a first information recording layer which only allows information to be read out and a second information recording layer which allows information to be additionally recorded or to be rewritten, includes the steps of: (a) comparing, at a time of ejection of the information recording medium, (i) recorded relevant information which is recorded on the second information recording layer as information related to registered information recorded on the first information recording layer and (ii) record management information indicative of attribute information of recorded relevant information which is present in the second information recording layer from a time of insertion of the information recording medium; and (b) selecting, based on a result of the comparison in the step (a), relevant information for recording, which is information to be recorded on the second information recording layer, from among the recorded relevant information which is recorded on the second information recording layer as the information related to the registered information recorded on the first information recording layer.

According to the arrangement, the comparing means (comparing step) compares, at the time of ejection of the information recording medium including the first information recording layer and the second information recording layer, (i) recorded relevant information which is recorded on the second information recording layer and which is related to registered information and (ii) record management information indicative of attribute information of recorded relevant information which is present in the second information recording layer from a time of insertion of the information recording medium, and, based on a result of the comparison, the selecting means (selecting step) selects, from among the recorded relevant information, relevant information for recording which should be allowed to remain on the second information recording layer of the information recording medium in which registered information is recorded on the first information recording layer.

The recording/reproducing device therefore can eliminate the need for user's operations (exchange of information recording media etc.) which have been conventionally required in a case where the registered information and the information (relevant information for recording) related to the registered information are recorded on different information recording media. This can improve convenience for a user.

Moreover, since only recorded relevant information which is not recorded on the information recording medium at the time of insertion of the information recording medium can be selected as relevant information for recording which should be recorded, it is possible to effectively utilize a storage capacity of the information recording medium.

Moreover, the relevant information for recording which should be allowed to remain on the information recording medium is selected when use of the inserted information recording medium in the recording/reproducing device is finished (i.e., when the information recording medium is ejected). This eliminates the need for carrying out processes such as (i) selecting the relevant information for recording many times during intervals between various operations in the recording/reproducing device such as a reproducing operation or (ii) selecting the relevant information for recording by temporarily stopping these operations. That is, it is possible to collectively select relevant information for recording which should be recorded on the second information recording layer while maintaining processing efficiency of the recording/reproducing device.

Therefore, the recording/reproducing device (the method for controlling the recording/reproducing device) of the present invention produces an effect that it is possible to easily manage information related to registered information recorded in advance on an information recording medium without bothering a user by causing the information to be recorded on the information recording medium.

### Advantageous Effects of Invention

As described above, a recording/reproducing device of the present invention includes: comparing means for comparing, at a time of ejection of the information recording medium, recorded information which is recorded on the second information recording layer and recorded relevant information which is stored in the recording/reproducing device and which is related to registered information recorded on the first information recording layer; and selecting means for selecting, based on a result of the comparison by the comparing means, relevant information for recording, which is information to be recorded on the second information recording layer, from among the recorded relevant information.

As described above, a method of the present invention for controlling a recording/reproducing device includes the steps of: (a) comparing, at a time of ejection of the information recording medium, recorded information which is recorded on the second information recording layer and recorded relevant information which is stored in the recording/reproducing device and which is related to registered information recorded on the first information recording layer; and (b) selecting, based on a result of the comparison in the step (a), relevant information for recording, which is information to be recorded on the second information recording layer, from among the recorded relevant information.

As described above, a recording/reproducing device of the present invention includes: comparing means for comparing, at a time of ejection of the information recording medium, (i) recorded relevant information which is recorded on the second information recording layer and which is related to registered information recorded on the first information recording layer and (ii) record management information indicative of attribute information of recorded relevant information which is present in the second information recording layer from a time of insertion of the information recording medium; and selecting means for selecting, based on a result of the comparison by the comparing means, relevant information for recording, which is information to be recorded on the second information recording layer, from among the recorded relevant information.

As described above, a method of the present invention for controlling a recording/reproducing device includes the steps of: (a) comparing, at a time of ejection of the information recording medium, (i) recorded relevant information which is recorded on the second information recording layer and which is related to registered information recorded on the first information recording layer and (ii) record management information indicative of attribute information of recorded relevant information which is present in the second information recording layer from a time of insertion of the information recording medium; and (b) selecting, based on a result of the comparison in the step (a), relevant information for recording, which is information to be recorded on the second information recording layer, from among the recorded relevant information.

Therefore, the recording/reproducing device (the method for controlling the recording/reproducing device) of the present invention produces an effect that it is possible to easily manage information related to registered information recorded in advance on an information recording medium without bothering a user by causing the information to be recorded on the information recording medium.

### BRIEF DESCRIPTION OF DRAWINGS

FIG. 1 is a block diagram illustrating an example of an outline configuration of a recording/reproducing device in a recording/reproducing system of an embodiment of the present invention.

FIG. 2 is a block diagram illustrating an outline configuration of a recording/reproducing system of the embodiment or another embodiment of the present invention.

FIG. 3 is a view illustrating an example of an outline configuration of an optical disc which is inserted into the recording/reproducing device of the embodiment of the present invention, FIG. 3(a) is a view illustrating the optical disc, which view is taken from a reproducing light incident side, and FIG. 3(b) is a view illustrating an exemplary configuration of layers of the optical disc.

FIG. 4 is a view showing an example of file management information used in the recording/reproducing device of the embodiment of the present invention, FIG. 4(a) is a view showing attribute information of file management information managed in an optical disc, FIG. 4(b) is a view showing an example of attribute information belonging to a single file, FIG. 4(c) is a view showing another example of the attribute information, and FIG. 4(d) is a view showing still another example of the attribute information.

FIG. 5 is a flowchart showing a process flow in the recording/reproducing device of the embodiment of the present invention.

FIG. 6 is a block diagram illustrating an example of an outline configuration of a recording/reproducing device in a recording/reproducing system of another embodiment of the present invention.

FIG. 7 is a flowchart showing an example of a flow of processes carried out in the recording/reproducing device of the another embodiment of the present invention when reproduction of registered information is stopped.

FIG. 8 is a flowchart showing an example of a flow of processes carried out in the recording/reproducing device of the another embodiment of the present invention when the recording/reproducing device is turned off.

FIG. 9 is a flowchart showing an example of a flow of processes carried out in the recording/reproducing device of the another embodiment of the present invention when downloading of relevant information is completed.

FIG. 10 is a flowchart showing an example of a flow of processes carried out in the recording/reproducing device of the another embodiment of the present invention when an optical disc is ejected.

### DESCRIPTION OF EMBODIMENTS

### Embodiment 1

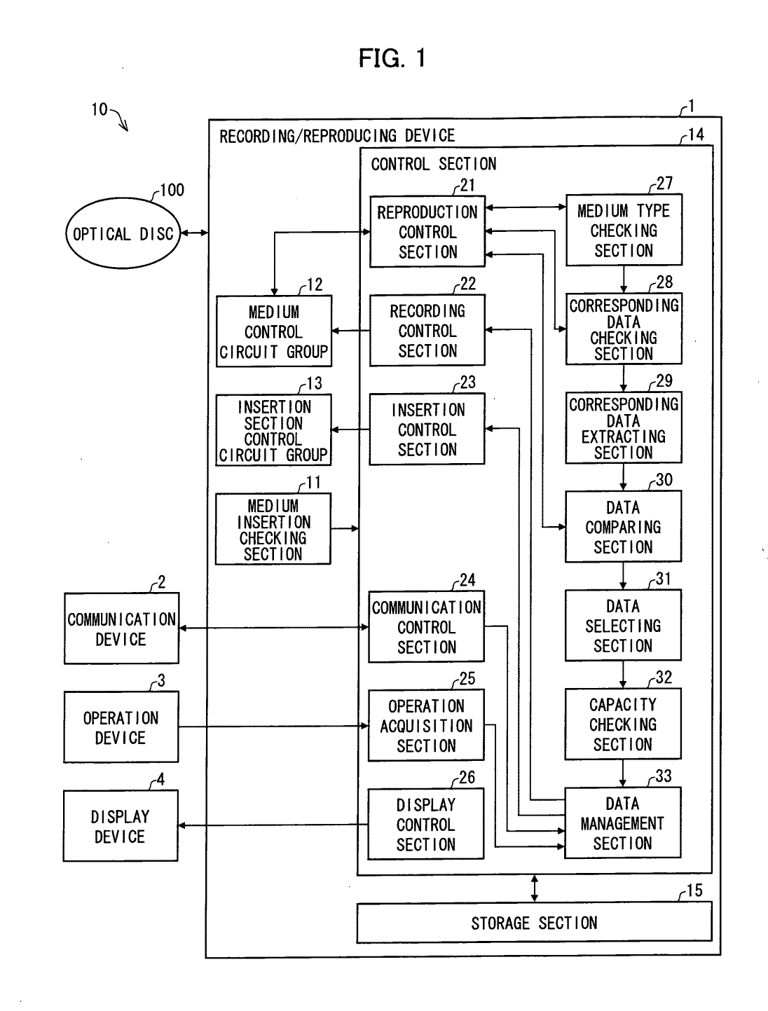

An embodiment of the present invention is described below with reference to FIGS. 1 through 5.

[Outline of Recording/Reproducing System 10]

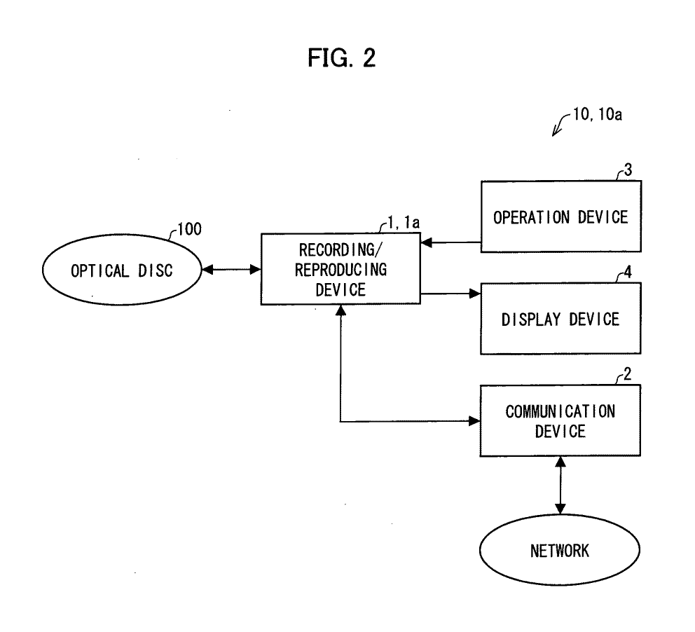

First, a recording/reproducing system 10 of the present embodiment is described with reference to FIG. 2. FIG. 2 is a block diagram illustrating an outline configuration of the recording/reproducing system 10 of the present embodiment. As illustrated in FIG. 2, the recording/reproducing system 10 includes recording/reproducing device 1, a communication device 2, an operation device 3, and a display device 4. The recording/reproducing device 1 is capable of carrying out data communication with the communication device 2, the operation device 3, and the display device 4 via communication means such as wired, wireless or infrared communication. That is, in the present embodiment, the recording/reproducing device 1 controls the communication device 2 and the operation device 3. Note that another arrangement is also possible in which the recording/reproducing device 1 has functions of the communication device 2 and the operation device 3. The recording/reproducing device 1 will be described later.

The communication device 2 is a device that is capable of carrying out data communication, via a network (e.g., Internet), with a content server (not shown) or the like which stores relevant information related to registered information, such as a content or software, which is recorded in advance on an optical disc 100 (information recording medium) (later described) and whose reproduction can be controlled by the recording/reproducing device 1. Further, the communication device 2 transmits, to the recording/reproducing device 1, the relevant information acquired, by the communication device 2, from the content server, for example, under the control of a communication control section 24 of the recording/reproducing device 1.

Note that the relevant information refers to information which is related to the registered information recorded in advance on the optical disc 100 (information recording medium) and which is associated with the registered information or utilized together with the registered information. Examples of the relevant information include update information for updating the registered information, an additional content (additional information) such as text information (e.g., subtitles) related to the registered information, and an advertisement video such as a preview of a new movie. The examples of the relevant information also include supplementary information for supplementing incomplete registered information recorded in advance on the optical disc 100. In the Embodiment 1, relevant information stored in a storage section 15 may be referred to as “recorded relevant information”.

The operation device 3 is a device by which a user carries out an input operation while looking at an image displayed on the display device 4. Examples of the operation device 3 include a remote controller having various kinds of keys such as an “ENTER” key and arrow keys, a mouse, a touch pad, and a microphone (audio input device).

The display device 4 is a device which is controlled, for example, by a display control section 26 of the recording/reproducing device 1 so as to display information necessary for controlling the recording/reproducing device 1 such as registered information (e.g., content) read out from the optical disc 100, relevant information (e.g., subtitles) acquired via a network, and an image for accepting a user's input. The display device 4 is constituted by a liquid crystal panel, for example. However, the present embodiment is not limited to this. An organic EL (Electro Luminescence) panel may be used as the display device 4. Note that the recording/reproducing system 10 may include, as a device for providing a user with information, an audio output device such as a speaker in addition to the display device 4.

In the present embodiment, an optical information recording medium such as a DVD or a BD can be inserted into the recording/reproducing device 1. The present embodiment deals with especially a case where the optical disc 100 is inserted into the recording/reproducing device 1. The optical disc 100 will be described layer.

[Configuration of Recording/Reproducing Device 1]

Next, with reference to FIG. 1, the following deals with an example of an outline configuration of the recording/reproducing device 1 in the recording/reproducing system 10 of the present embodiment. FIG. 1 is a block diagram illustrating an example of an outline configuration of the recording/reproducing device 1 in the recording/reproducing system 10 of the present embodiment.

The recording/reproducing device 1 is a device which controls recording or reproduction of information on/from the optical information recording medium or the optical disc 100 of the present embodiment, and includes a medium insertion checking section 11, a medium control circuit group 12, an insertion control circuit group 13, a control section 14, and the storage section 15.

The medium insertion checking section 11 detects insertion of an information recording medium such as the optical disc 100. The medium insertion checking section 11 is, for example, realized by various kinds of sensors, but may be any detection device as long as it can detect insertion of an information recording medium. Further, the medium insertion checking section 11 outputs a result of the detection as a detection signal to the control section 14.

The medium control circuit group 12 records/reproduces information on/from an information recording medium under control of the control section 14. Examples of the information to be recorded on the information recording medium include relevant information acquired from the content server (not shown) via the communication device 2. Examples of the information to be read out and reproduced from the information recording medium include registered information.

The insertion section control circuit group 13 controls, under control of an insertion control section 23 of the control section 14, an insertion section (e.g., slot) (not shown) into which an information recording medium is to be inserted. For example, the insertion section control circuit group 13 controls the insertion section so that the optical disc 100 is ejected from the insertion section.

The control section 14 mainly includes a reproduction control section 21 (reproduction control means), a recording control section 22 (recording control means), the insertion control section 23, the communication control section 24 (acquisition means), an operation acquisition section 25 (acquisition means), the display control section 26, a medium type checking section 27 (medium determining means), a corresponding data checking section 28 (determining means), a corresponding data extracting section 29, a data comparing section 30 (comparing means), a data selecting section 31 (selecting means), a capacity checking section 32, and a data management section 33 (storage control means, deleting means). The control section 14 controls members constituting the recording/reproducing device 1, for example, by executing a control program. The control section 14 carries out various processing by executing a program stored in the storage section 15 provided in the recording/reproducing device 1 after reading out, as needed, to a primary storage section (not shown) constituted by a RAM (Random Access Memory) for example. The following discusses configurations of substantial parts of the control section 14.

The reproduction control section 21 controls reproduction of information from an optical information recording medium such as the optical disc 100. The reproduction control section 21 controls especially reproduction of registered information such as a content and software recorded on a ROM layer of the optical disc 100. In addition, the reproduction control section 21 controls reproduction of recorded information such as relevant information related to the registered information and file management information (record management information) indicative of attribute information of the relevant information, which recorded information is recorded on an RE layer of the optical disc 100.

That is, the recorded information refers to information which is recorded in advance on the RE layer or information which is recorded on the RE layer by the recording/reproducing device 1. Examples of the recorded information include relevant information which is recorded on the RE layer before insertion, relevant information which is recorded on the RE layer after insertion, and file management information of the relevant information.

The recording control section 22 controls recording of information on an optical information recording medium such as the optical disc 100. The recording control section 22 records, for example, relevant information for recording (later described) selected by the data selecting section 31 on the RE layer of the optical disc 100. In addition, the recording control section 22 causes file management information of the relevant information recorded on the RE layer of the optical disc 100 to be recorded, as recorded information, on the RE layer.

The insertion control section 23 controls the insertion section control circuit group 13 so that ejection of the optical disc 100 inserted into the insertion section (not shown) is controlled.

The communication control section 24 controls data communication with the communication device 2, and acquires relevant information acquired via a network by the communication device 2. Further, the communication control section 24 externally acquires relevant information during reproduction of registered information by the reproduction control section 21.

The operation acquisition section 25 acquires, for example, an instruction to eject the optical disc 100, as a user's input via the operation device 3. Further, the operation acquisition section 25 acquires, as a user's input, relevant information related to registered information recorded on the optical disc 100. In other words, the operation acquisition section 25 externally acquires relevant information during reproduction of registered information by the reproduction control section 21.

During reproduction of registered information, in response to an instruction from a user, the communication control section 24 acquires relevant information related to the registered information, for example, from the content server via a network with the use of the communication device 2, and the operation acquisition section 25 acquires information (relevant information) which is related to the registered information and which is inputted by the user with the use of the operation device 3. That is, the communication control section 24 or the operation acquisition section 25 externally acquires relevant information related to registered information during reproduction of the registered information. The relevant information thus acquired is transmitted to the data management section 33.

The display control section 26 controls the display device 4 so as to cause the display device 4 to display registered information, relevant information, an inquiry image for a user, and the like. Thus, the registered information, the relevant information, the inquiry image for a user, and the like are displayed on the display device 4.

The medium type checking section 27 checks whether a disc inserted into the recording/reproducing device 1 is the optical disc 100 or not. In other words, the medium type checking section 27 determines whether or not a disc (information recording medium) inserted into the recording/reproducing device 1 includes a ROM layer and an RE layer.

The corresponding data checking section 28 checks whether or not an individual number (individual identification information) contained in disc identification information (later described) read out from the RE layer (management area 101 (later described)) of the optical disc 100 matches an identification number (individual identification information) given to data (e.g., relevant information) recorded on the storage section 15. Thus, the corresponding data checking section 28 checks whether or not the storage section 15 contains data (corresponding data) whose identification number matches the individual number. In other words, the corresponding data checking section 28 determines whether or not an individual number for identifying the optical disc 100 which individual number is recorded on the optical disc 100 matches an identification number contained in relevant information recorded on the storage section 15.

The corresponding data extracting section 29 extracts the corresponding data from the storage section 15.

The data comparing section 30 compares, at the time of ejection of the optical disc 100, recorded information recorded on the RE layer and relevant information which is stored in the recording/reproducing device 1 and which is related to registered information recorded on the ROM layer

Specifically, the data comparing section 30 checks whether or not there is file management information on the optical disc 100. In a case where there is file management information, the data comparing section 30 compares the file management information and attribute information of the corresponding data recorded on the storage section 15. In this case, the data comparing section 30 compares the file management information read out by the reproduction control section 21 and the relevant information stored in the recording/reproducing device 1.

In a case where it is determined, as a result of the comparison, that there is corresponding data which has attribute information different from attribute information contained in the file management information, the data comparing section 30 determines that the storage section 15 contains corresponding data which is not recorded on the RE layer of the optical disc 100 (determines that “there is additional data”). Meanwhile, in a case where there is no corresponding data which has attribute information different from attribute information contained in the file management information, the data comparing section 30 determines that all corresponding data contained in the storage section 15 has been already recorded on a user data area 103 of the RE layer (determines that “there is no additional data”).

Meanwhile, in a case where there is no file management information on the optical disc 100, it is determined that data (corresponding data) extracted by the corresponding data extracting section 29 is first data (new data) recorded on the RE layer of the optical disc 100 as relevant information related to registered information of the optical disc 100.

Note that relevant information itself recorded on the optical disc 100 may be used instead of the file management information in determining whether or not there is additional data or whether or not there is new data.

Further, in a case where the medium type checking section 27 determines that the optical disc 100 has an ROM layer and an RE layer and in a case where the corresponding data checking section 28 determines that the individual number (individual identification information) matches the identification number (individual identification information), the data comparing section 30 compares recorded information recorded on the RE layer of the optical disc 100 and relevant information stored in the storage section 15.

The data selecting section 31 selects additional data or new data as relevant information for recording, which is to be recorded on the RE layer of the optical disc 100, in a case where the data comparing section 30 determines that the additional data or the new data is stored in the storage section 15. In other words, the data selecting section 31 selects, based on a result of the comparison by the data comparing section 30, relevant information for recording to be recorded on the RE layer from among relevant information (recorded relevant information) stored in the storage section 15.

That is, the data comparing section 30 deducts relevant information stored in the optical disc 100 from the relevant information stored in the storage section 15, and selects remaining relevant information as relevant information for recording to be recorded on the RE layer of the optical disc 100.

The capacity checking section 32 checks a free space of the RE layer of the optical disc 100 to confirm whether or not the relevant information for recording can be recorded on the optical disc 100.

The data management section 33 determines at which position (address information) of the RE layer of the optical disc 100 the relevant information for recording selected by the data selecting section 31 is to be recorded, and adds the position to attribute information of the relevant information for recording. Thus, the recording control section 22 can record the relevant information for recording on a predetermined position of the RE layer of the optical disc 100.

Further, the data management section 33 creates or updates file management information with the use of the attribute information of the relevant information for recording selected by the data selecting section 31. This file management information is recorded on the RE layer of the optical disc 100 by the recording control section 22.

Further, the data management section 33 causes the recording control section 22 to delete the additional data or the new data that has been recorded on the optical disc 100 from the storage section 15 after the relevant information for recording and the file management information are recorded on the optical disc 100 and before the optical disc 100 is ejected. In other words, the data management section 33 causes the recording control section 22 to delete relevant information which has been selected as the relevant information for recording by the data selecting section 31 and which is stored in the recording/reproducing device 1.

Further, in a case where relevant information is externally acquired during reproduction of the registered information, the data management section 33 assigns, as an identification number, an individual number of the inserted optical disc 100 to attribute information of the relevant information, and causes the relevant information to which the identification number is assigned to be stored in the storage section 15.

Note that relevant information to be stored in the storage section 15 is not limited to data (relevant information etc.) downloaded from a network by the communication control section 24 or data inputted by a user, but may be data generated by an internal application of the recording/reproducing device 1.

The storage section 15 stores (i) a control program for each section, (ii) an OS program, (iii) an application program, and (iv) various kinds of data read out when these programs are executed by the control section 14. The storage section 15 is constituted by a storage device such as an HDD or a semiconductor memory or, according to need, constituted by a nonvolatile storage device such as a ROM (Read Only Memory) or a flash memory. The primary storage section is constituted by a volatile storage device such as a RAM. Note, however, that the present embodiment may be described on the assumption that the storage device 15 includes a function of the primary storage section (buffer). The storage section 15 stores relevant information acquired from the content server for example.

The present embodiment deals with a case where the storage section 15 is provided in the recording/reproducing device 1, but is not limited to this. The storage section 15 may be realized by an external device, such as an external HDD, that is different from the recording/reproducing device 1.

[Configuration of Optical Disc 100]

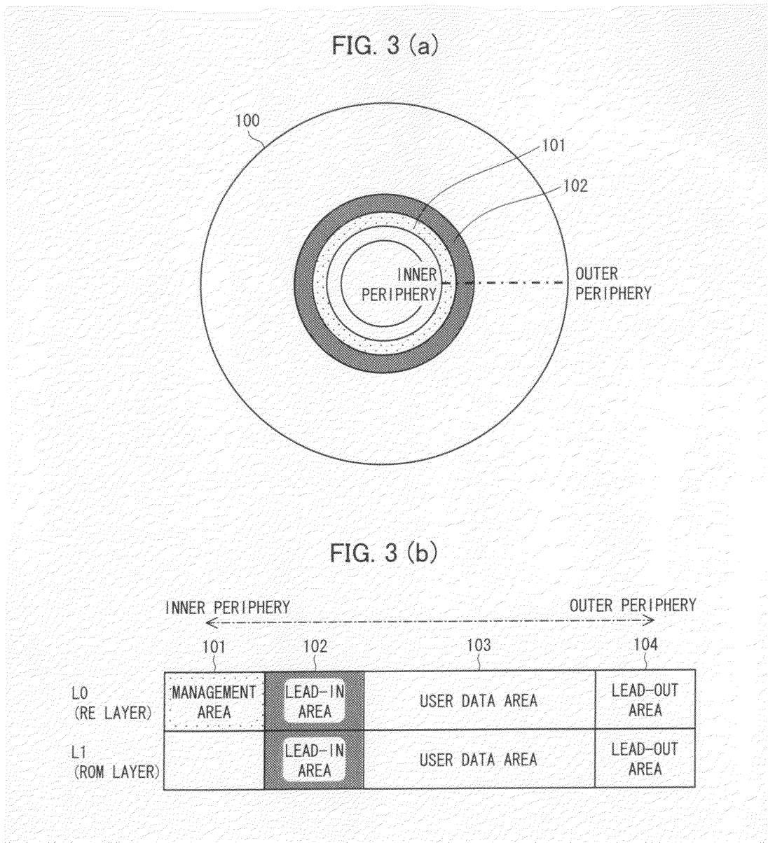

Next, with reference to FIG. 3, the following describes an example of an outline configuration of the optical disc 100 of the present embodiment. FIG. 3 is a view illustrating an example of an outline configuration of the optical disc 100 of the present embodiment. FIG. 3(a) is a view illustrating the optical disc 100, which view is taken when the optical disc 100 is viewed from a reproducing light incident side. FIG. 3(b) is a view illustrating an exemplary configuration of recording layers of the optical disc 100.

As illustrated in FIG. 3(a), the optical disc 100 has a management area 101 and a lead-in area 102 on an inner peripheral side.

The management area 101 is an innermost area of the optical disc 100, and is provided on a recording layer (RE layer) that is farthest from the reproducing light incident side. The management area 101 is an area which does not require tracking control or is a barcode-like recording area which can be accessed only by focus control. Examples of the management area 101 include a BCA (Burst Cutting Area). When the optical disc 100 is inserted, the recording/reproducing device 1 for example is designed to read information of the management area 101 first. The management area 101 is an area onto which information can be written only at a manufacturing stage (i.e., an unrewritable area).

On the management area 101, disc identification information indicative of a structure of the optical disc 100 is mainly recorded. Specific examples of the disc identification information include a type (reproduction-only type, write-once type, rewritable type) of the recording layer of the optical disc 100, a size of the optical disc 100, a version (associated with speed etc.) of the optical disc 100, a polarity of a servo, a polarity of a recording mark, a number (individual number) specific to the optical disc 100. These various kinds of disc identification information may be recorded in any order (may be disposed in any way) on the management area 101. Note that the order in which these various kinds of disc identification information are recorded is normally determined based on a standard etc.

The lead-in area 102 is provided on an outer peripheral side of the optical disc 100 so as to be outside of the management area 101, and is provided in each recording layer. The lead-in area 102 is a first recording area to be irradiated with reproducing light (first recording area whose information is read out) under control of the recording/reproducing device 1 when the recording/reproducing device 1 carries out processing with respect to each layer. Further, the lead-in area 102 has an area onto which information can be written only at the manufacturing stage (i.e., unrewritable area) and an area in which information can be rewritten after the optical disc 100 is inserted into the recording/reproducing device 1. Examples of information to be recorded on the lead-in area 102 include a standard condition for recording/reproducing of information on/from the optical disc 100, information indicative of whether an access of the recording/reproducing device 1 to each layer is allowed or not (i.e., information indicative of access restriction), and information indicative of a location of a flaw generated during manufacturing or during use. Note that the information indicative of a location of a flaw is recorded on a flaw management area within the lead-in area 102 and a lead-out area 104.

FIG. 3(b) illustrates a configuration of the optical disc 100. In FIG. 3(b), recording layers of the optical disc 100 are referred to as recording layer L0, recording layer L1, . . . from the farthest side from the reproducing light incident side. The recording layer L0 is an RE layer (rewritable recording layer) which is a recordable area on which information can be recorded, and the recording layer L1 is a ROM layer (reproduction-only recording layer) which is a reproduction-only area from which information can be read out. Note that the RE layer may be an R (recordable) layer which is a write-once recording layer. In FIG. 3(b), only the recording layers L0 and L1 are shown. However, another arrangement is possible in which another recording layer is additionally provided on the reproducing light incident side. In other words, the optical disc 100 includes a ROM layer (first information recording layer), which is a read-only layer, and an R layer or an RE layer (second information recording layer), which are write-once layer and rewritable layer, respectively.

As illustrated in FIG. 3(b), each of the recording layer L0 (RE layer) and the recording layer L1 (ROM layer) includes the read-in layer 102, a user data area 103, and the lead-out area 104. The RE layer further includes the management area 101. Note that the management area 101 has been described above, and therefore is not explained repeatedly.

Recorded on the lead-in area 102 of the RE layer is, for example, file management information indicative of attribute information of relevant information (file) that is recorded on the user data area 103 of the RE layer. The attribute information (file attribute information) refers to information added to a file such as a file name, a file size, creation date and time, and update date and time. Note that a file such as relevant information may be hereinafter referred to simply as “data”. Note also that an area on which the file management information is recorded is not limited to this, and therefore the file management information may be recorded on the user data area 103 of the RE layer as described later.

On the user data area 103 of the ROM layer, registered information is recorded at the manufacturing stage. Meanwhile, on the user data area 103 of the RE layer, for example, relevant information that is acquired from the content server by the recording/reproducing device 1 is recorded. In other words, recorded on the user data area 103 of the RE layer is relevant information for recording which is selected from recorded relevant information which is stored in the storage section 15 of the recording/reproducing device 1 and which is related to the registered information recorded on the ROM layer.

The lead-out area 104 is normally provided on an outermost periphery of each layer of the optical disc 100. On the lead-out area 104, information such as the information indicative of a location of a flaw is recorded.

The present embodiment deals with a case where the optical disc 100 is a two-layer BD constituted by an RE layer (R layer) and a ROM layer, but is not limited to this. Another arrangement is also possible in which the optical disc 100 is a multi-layer medium including at least one RE layer (R layer) and at least one ROM layer. In other words, the optical disc 100 is a so-called hybrid disc constituted by a plurality of information recording layers having different recording characteristics such as a ROM layer, an RE layer, and an R layer.

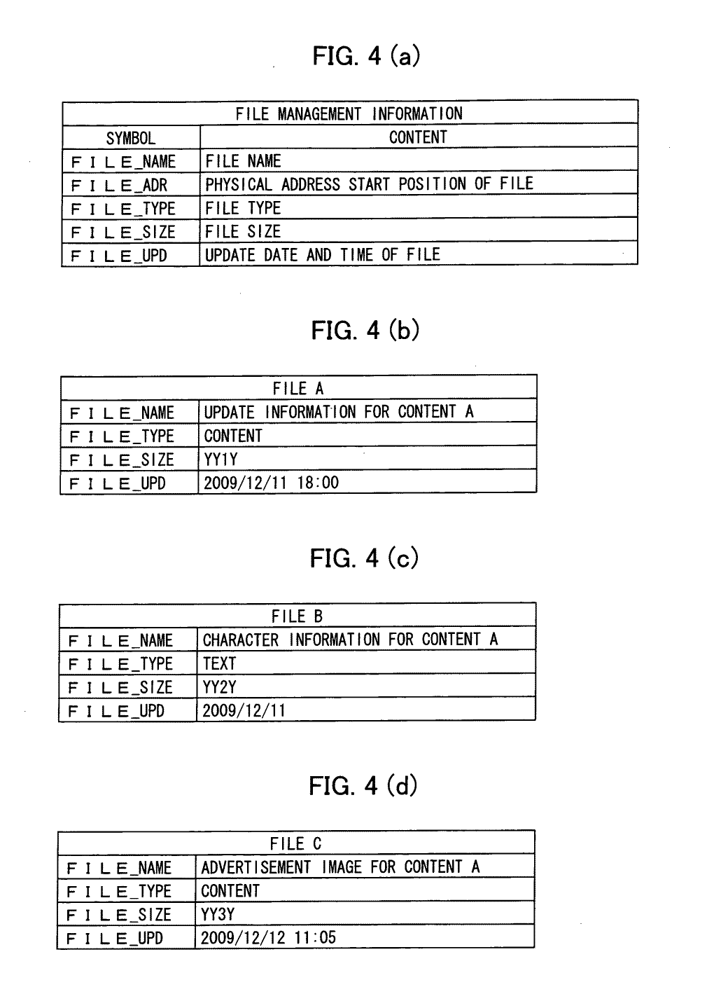

Next, with reference to FIG. 4, the following describes file management information in detail. FIG. 4 is a view showing an example of file management information. FIG. 4 (a) is a view showing attribute information of file management information managed in the optical disc 100, FIG. 4(b) is a view showing an example of attribute information belonging to a single file, FIG. 4(c) is a view showing another example of the attribute information, and FIG. 4(d) is a view showing still another example of the attribute information.

As shown in FIG. 4(a), the file management information includes various kinds of attribute information represented by “FILE_NAME”, “FILE_ADR”, “FILE_TYPE”, “FILE_SIZE”, “FILE_UPD” etc., respectively.

The “FILE_NAME” represents a file name such as “UPDATE INFORMATION FOR CONTENT A”.

The “FILE_ADR” represents file physical address information, such as “XX1 . . . ”, which indicates, for example, an address on the user data area 103 of the RE layer which address is assigned by the recording/reproducing device 1.

The “FILE_TYPE” represents information indicative of a file type such as “CONTENT”, “mpeg” or “TEXT”.

The “FILE_SIZE” represents information indicative of a file size such as “YY1Y (megabyte)”.

The “FILE_UPD” represents information indicative of creation date and time (creation date) of a file or update date and time (update date) of a file such as “2009/12/11 18:00”.

Such file attribute information allows a plurality of files to be managed in various ways. For example, the “FILE_NAME” allows a plurality of files to be physically separated, and the “FILE_UPD” allows a plurality of files to be classified according to time.

For example, it is assumed that (i) “content A” is recorded as registered information on the ROM layer of the optical disc 100, and (ii) a file A, which is update information for the content A, a file B, which is character information for the content A, and a file C, which is an advertisement image for the content A are recorded, as information related to the content A, on the RE layer of the optical disc 100. That is, the attribute information shown in FIG. 4(b), the attribute information shown in FIG. 4(c), and the attribute information shown in FIG. 4(d) belong to the files A through C, respectively.

Each of the files A through C is relevant information which is acquired, for example, from the content server by the recording/reproducing device 1 and which is then stored in the storage section 15. Each of the files A through C is recorded on the RE layer of the optical disc 100 by later-described processing of the recording/reproducing device 1. In this case, address information indicative of addresses of the files A through C on the RE layer are assigned, by the recording/reproducing device 1, to respective attribute information of the files A through C shown in FIGS. 4(b) through 4(d). A collection of these pieces of attribute information to which the address information is assigned forms file management information to be recorded on the optical disc 100 on which the content A is recorded as registered information.

[Process Flow in Recording/Reproducing Device 1]

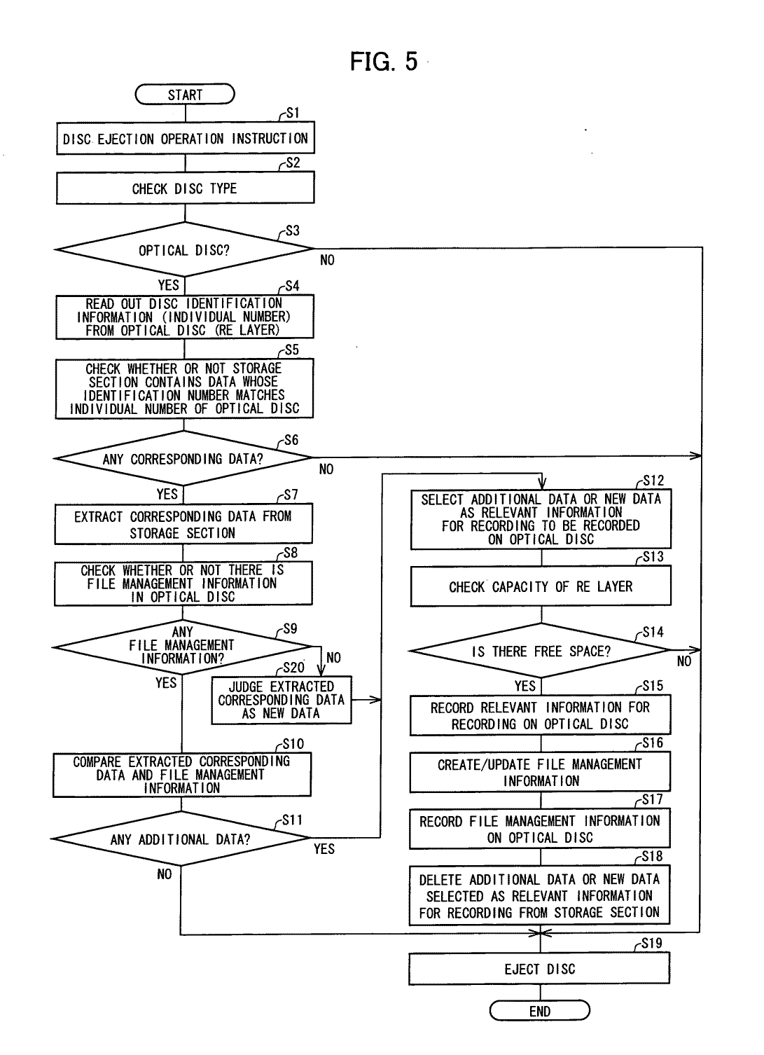

Next, with reference to FIG. 5, the following deals with a process flow in the recording/reproducing device 1. More specifically, the following deals with a process flow in the recording/reproducing device 1 carried out in a case where, at the time of ejection of the optical disc 100, data stored in the storage section 15 (local memory) and data recorded on the RE layer of the optical disc 100 are compared, and then the data stored in the storage section 15 is recorded. FIG. 5 is a flow chart showing a process flow in the recording/reproducing device 1.

When the optical disc 100 having registered information on its ROM layer is inserted into the recording/reproducing device 1, the insertion or an instruction from a user to reproduce the registered information acts as a trigger which causes the reproduction control section 21 to read out and reproduce the registered information. Further, when the optical disc 100 is inserted, the reproduction control section 21 reads out disc identification information indicative of a structure of the optical disc 100 from the management area 101, and then transmits the disc identification information to the data management section 33.

During reproduction of the registered information, in response to an instruction from the user, the communication control section 24 causes the communication device 2 to acquire relevant information related to the registered information from the content server for example via a network, and the operation acquisition section 25 acquires information which is related to the registered information and which is inputted by the user with the use of the operation device 3. That is, the communication control section 24 or the operation acquisition section 25 externally acquires relevant information related to registered information during reproduction of the registered information. The relevant information thus acquired is transmitted to the data management section 33.

After acquiring the relevant information, the data management section 33 assigns, as an identification number of the relevant information, an individual number extracted from the disc identification information read out by the reproduction control section 21 to attribute information of the relevant information. Then, the data management section causes the relevant information to which the identification number has been assigned to be stored in the storage section 15.

These processes are thus carried out in the recording/reproducing device 1 before the processes in the flowchart shown in FIG. 5 are carried out. The following description discusses the flowchart shown in FIG. 5.

First, the operation acquisition section 25 acquires an instruction to eject an optical disc from the insertion section (not shown) (disc ejecting operation instruction) (Step S1 (hereinafter referred to simply as “S1”)). For example, in a case where a user inputs an instruction to eject the optical disc with the use of the operation device 3, an input signal indicative of the input is transmitted to the operation acquisition section 25.

The operation acquisition section 25 transmits the input signal to the medium type checking section 27. In response to this, the medium type checking section 27 checks a type of the inserted disc (disc type) (S2). For this purpose, the medium type checking section 27 gives the reproduction control section 21 an instruction to read out the disc identification information from the management area 101. In response to receipt of this instruction, the reproduction control section 21 controls the medium control circuit group 12 so that the disc identification information is read out. Then, the reproduction control section 21 transmits the disc identification information thus read out to the medium type checking section 27. In response to this, the medium type checking section 27 determines, based on the disc identification information, whether or not the inserted disc is the optical disc 100 (hybrid disc) (S3).

Here, it is assumed that registered information recorded on the optical disc 100 is being reproduced in the recording/reproducing device 1, but the optical disc 100 may be replaced by another optical disc in the middle of the reproduction, for example, in response to an instruction from a user before the processes of FIG. 5 are carried out. In view of this, it is confirmed, also when the disc ejecting operation instruction is acquired, whether or not the inserted disc is a hybrid disc. This allows relevant information related to the registered information recorded on the optical disc 100 to be surely recorded.

In a case where the medium type checking section 27 determines that the inserted optical disc is the optical disc 100 (YES in S3), the medium type checking section notifies the corresponding data checking section 28 that the inserted optical disc is the optical disc 100. In response to receipt of this notification, the corresponding data checking section 28 gives the reproduction control section 21 an instruction to read out the disc identification information containing an individual number from the RE layer (the management area 101) of the optical disc 100. In response to receipt of this instruction, the reproduction control section 21 reads out the disc identification information from the management area 101 of the optical disc 100, and then transmits the disc identification information thus read out to the corresponding data checking section 28 (S4).

After receiving the disc identification information, the corresponding data checking section 28 extracts the individual number from the disc identification information, and then checks whether or not data having an identification number which matches this individual number is stored in the storage section 15 (S5). Specifically, the corresponding data checking section 28 reads out attribute information of all the data stored in the storage section 15, extracts identification numbers assigned, when these data are acquired, to the respective attribute information, and compares the identification numbers and the extracted individual number so as to determine whether or not data whose identification number matches the individual number is stored in the storage section 15 (S6).

In a case where it is determined that such data (corresponding data) whose identification number matches the individual number is stored in the storage section 15 (YES in S6), the corresponding data checking section 28 notifies the corresponding data extracting section 29 that such data (corresponding data) whose identification number matches the individual number is stored in the storage section 15. In response to receipt of this notification, the corresponding data extracting section 29 extracts the corresponding data from the storage section 15, and then transmits the corresponding data to the data comparing section 30 (S7).

After receiving the corresponding data, the data comparing section 30 checks whether or not file management information is recorded on the optical disc 100 (S8). Specifically, the data comparing section 30 gives the reproduction control section 21 an instruction to read out the file management information from the RE layer of the optical disc 100. In response to receipt of this instruction, the reproduction control section 21 reads out the file management information in a case where the file management information is recorded on the RE layer, and then transmits the file management information to the data comparing section 30. The data comparing section determines that “there is file management information” in the optical disc 100 in a case where the file management information is received, whereas the data comparing section determines that “there is no file management information” in the optical disc 100 in a case where the file management information is not received, for example, within a predetermined period of time after the transmission of the instruction to read out the file management information (S9).

In a case where it is determined that there is file management information in the optical disc 100 (YES in S9), the data comparing section 30 compares the corresponding data received in S7 from the corresponding data extracting section 29 (the data extracted by the corresponding data extracting section 29) and the file management information read out from the optical disc 100 (S10). Specifically, the data comparing section 30 compares attribute information of the corresponding data and attribute information contained in the file management information so as to determine whether or not the attribute information of the file management information contains attribute information that is different from the attribute information of the corresponding data. In a case where there is corresponding data having attribute information that is different from the attribute information of the file management information, the data comparing section 30 determines that corresponding data which is not recorded on the RE layer (the user data area 103) of the optical disc 100 is stored in the storage section 15 (determines that “there is additional data”), whereas in a case where there is no corresponding data having attribute information that is different from the attribute information of the file management information, the data comparing section 30 determines that all the corresponding data stored in the storage section 15 have been already recorded on the user data area 103 of the RE layer (determines that “there is no additional data”) (S11). In a case where it is determined that there is additional data (YES in S11), the data comparing section 30 notifies the data selecting section 31 that there is additional data.

Meanwhile, in a case where it is determined that there is no file management information in the optical disc 100 (NO in S9), the data comparing section 30 determines that the corresponding data extracted in S7 by the corresponding data extracting section 29 is first data (new data) to be recorded, as relevant information related to the registered information of the optical disc 100, on the RE layer (the user data area 103) of the optical disc 100 (S20). Then, the data comparing section 30 notifies the data selecting section 31 that it has been determined that there is new data in the storage section 15.

In a case where the data selecting section 31 is notified that there is additional data (YES in S11) or in a case where the data selecting section 31 is notified in S20 that there is new data, the data selecting section 31 selects the additional data or the new data as relevant information for recording to be recorded on the RE layer (the user data area 103) of the optical disc 100 (S12). The data selecting section 31 notifies the capacity checking section 32 that the additional data or the new data has been selected as the relevant information for recording.

In response to receipt of this notification, the capacity checking section 32 checks a free space of the RE layer of the optical disc 100 in order to check whether or not the relevant information for recording can be recorded on the optical disc 100 (S13). Specifically, the capacity checking section 32 checks whether or not there is a free space in the optical disc 100 by examining a size (FILE_SIZE: see FIG. 4) of each data contained in the file management information read out in S8 (S14). Note that the capacity checking section 32 can recognize a full capacity of the RE layer (the user data area 103) of the optical disc 100 by examining the disc identification information (stored in the storage section 15 for example) which is read out, for example, when the disc type is determined in S2. Further, in a case where no file management information is read out in S8, the capacity checking section 32 determines that an entire apace is available.

In a case where it is determined that there is a free space (YES in S14), the capacity checking section 32 notifies the data management section 33 that there is a free space. In response to receipt of this notification, the data management section 33 determines on which position of the user data area 103 of the RE layer the relevant information for recording selected in S12 is to be recorded (determines address information), and adds the position to the attribute information of the relevant information for recording. Then, the data management section 33 notifies the recording control section 22 that the position on which the relevant information for recording is to be recorded has been determined. In response to receipt of this notification, the recording control section 22 controls the medium control circuit group 12 so that the relevant information for recording selected in S12 is read out from the storage section 15 and is then recorded on the RE layer (user data area 103) of the optical disc 100 (S15). After completion of the recording of the relevant information for recording, the recording control section 22 notifies the data management section 33 of the completion.

In response to receipt of this notification, the data management section 33 creates or updates file management information with the use of attribute information of all the selected relevant information for recording (so that the file management information contains all the attribute information) (S16). That is, in a case where the relevant information for recording is new data, the data management section 33 creates file management information with the use of attribute information of the new data since there is no file management information in the optical disc 100. Meanwhile, in a case where the relevant information for recording is additional data, attribute information of the additional data is added to the file management information read out in S8. Thus, the file management information is updated.

After completing the creation or update of the file management information, the data management section 33 notifies the recording control section 22 of the completion. In response to receipt of this notification, the recording control section 22 records the file management information on the RE layer of the optical disc 100 (S17). After completing the recording of the file management information, the recording control section 22 notifies the data management section 33 of the completion.

In response to receipt of this notification, the data management section 33 deletes, from the storage section 15, the additional data or the new data that has been selected as the relevant information for recording (i.e., that has been recorded on the optical disc 100) (S18). The data management section 33 notifies the insertion control section 23 that the data has been deleted from the storage section 15.

In response to receipt of this notification, the insertion control section 23 controls the insertion section control circuit group 13 so that the optical disc 100 inserted into the insertion section is ejected (S19). Thus, the processes shown in FIG. 5 are finished. Also in a case where the insertion control section 23 is notified of NO in S3, S6, S11 or S14, the insertion control section 23 carries out an ejection operation of the optical disc 100 upon receipt, from a corresponding section, of the notification.

Note that in a case where the file management information contains attribute information which is the same as additional data in file name but is different from the additional data only in update date and time, relevant information having such attribute information may be replaced by the additional data. In this case, this additional information is recorded on the same position as the data having the same file name as the additional data (i.e., the data having the same file name as the additional data is overwritten with the additional data).

The above description has dealt with a case where the processes in S16 and S17 (creation/update of file management information and subsequent recording of the file management information on the optical disc 100) are carried out after the process of S15 (recording of relevant information for recording on the optical disc 100). However, the present embodiment is not limited to this. Alternatively, another arrangement is possible in which the process in S15 is carried out after the processes in S16 and S17.

Further, the process in S18 (deletion, from the storage section 15, of additional data or new data selected as relevant information for recording) may be carried out after the process in S19 (ejection of the optical disc 100).

In the processes in S9 through S11, the data comparing section 30 judges whether or not there is additional data by using file management information recorded on the RE layer of the optical disc 100. However, the present embodiment is not limited to this. It is also possible that the data comparing section 30 judges whether or not there is additional data by using relevant information itself that is recorded on the RE layer (user data area 103) of the optical disc 100. Note that it is preferable, from a viewpoint of a time required for reading out data from the optical disc 100, that this judgment is made by using file management information.

[Effects in Recording/Reproducing Device 1]

The recording/reproducing device 1 (method for controlling the recording/reproducing device 1) of the present embodiment includes the data comparing section 30 (comparing step) which compares, at the time of ejection of the optical disc 100, recorded information recorded on the RE layer and relevant information (recorded relevant information) related to registered information recorded on the ROM layer which relevant information is stored in the recording/reproducing device 1; and the data selecting section 31 (selecting step) which selects, based on a result of the comparison by the data comparing section 30, relevant information for recording, which is information to be recorded on the RE layer, from the recorded relevant information.

According to the arrangement, the recording/reproducing device 1 can eliminate the need for user's operations (selection of relevant information for recording, exchange of optical discs etc.) which have been conventionally required in a case where the registered information and the information (relevant information for recording) related to the registered information are recorded on different optical discs. This can improve convenience for a user.

That is, the relevant information for recording is selected and recorded on the RE layer of the optical disc 100 at the time of ejection of the optical disc 100. This allows the relevant information for recording to be stored in the storage section 15 again when the optical disc 100 is inserted into the recording/reproducing device 1 again. Accordingly, the relevant information for recording can be easily restored in the device without the need for a user to carry out troublesome operations such as exchange of optical discs, thereby improving convenience for the user.

Moreover, since only recorded relevant information which is not recorded on the optical disc 100 can be selected as relevant information for recording, it is possible to shorten a time required for recording of relevant information for recording and to effectively utilize a storage capacity of the optical disc 100.

Further, the relevant information for recording to be recorded on the optical disc 100 is selected when use of the inserted optical disc 100 in the recording/reproducing device 1 is finished (i.e., when the optical disc 100 is ejected). This eliminates the need for carrying out processes such as (i) selecting the relevant information for recording many times during intervals between various operations in the recording/reproducing device 1 such as a reproducing operation or (ii) selecting the relevant information for recording by temporarily stopping these operations. That is, it is possible to collectively select relevant information for recording to be recorded on the RE layer while maintaining processing efficiency of the recording/reproducing device 1.

Therefore, the recording/reproducing device 1 produces an effect that it is possible to easily manage information related to registered information recorded in advance on the optical disc 100 without bothering a user by causing the information to be recorded on the information recording medium.

Further, at the time of ejection of the optical disc 100, the recording/reproducing device 1 checks, in S2 of FIG. 5, presence or absence of a disc and a type of the disc, and examines, in S13, a remaining capacity of the disc. Accordingly, the relevant information for recording selected by the data selecting section 31 can be recorded on the RE layer of the optical disc 100 after a status of the disc such as presence or absence of the disc, a type of the disc, and remaining capacity of the disc are examined.

Further, since the recording/reproducing device 1 includes the recording control section 22 for recording, on the RE layer, the relevant information for recording selected by the data selecting section 31, the relevant information for recording selected at the time of ejection of the optical disc 100 can be recorded on the RE layer of the optical disc 100 on which registered information related to the relevant information for recording is recorded. Moreover, even if relevant information for recording stored in the storage section 15 (recorded relevant information selected by the data selecting section 31) is deleted, it is unnecessary to acquire the relevant information for recording from another disc or a network every time the relevant information for recording is used.

Note that BD recorders and BD players that are currently available in the market do not have a function of recording, on an inserted optical disc, data acquired from a network such as relevant information stored in a storage device provided in (connected to) these devices. Further, in these devices, a user is only allowed to delete this data.

Accordingly, in a case where the user wants to use the data after having deleted the data, the user must go into the trouble of acquiring the data again, for example, by downloading the data. Moreover, in an environment that is not connected to a network, the data cannot be downloaded. This may result in that the data cannot be used again.

According to the recording/reproducing device 1, relevant information for recording is recorded on the RE layer of the optical disc 100 as described above, and therefore can be managed together with the reproduction medium which utilizes the data (medium on which registered information related to the data is recorded). As such, the recording/reproducing device 1 produces an effect that the data need not to be acquired again.

Further, according to the recording/reproducing device 1, the data comparing section 30 compares recorded relevant information stored in the recording/reproducing device 1 and recorded information recorded on the optical disc 100 in a case where it is determined that an individual number recorded on the optical disc 100 matches an identification number contained in the recorded relevant information. As such, relevant information for recording to be recorded on the optical disc 100 can be selected after the optical disc 100 on which the recorded relevant information is to be recorded is surely specified.

Further, the data management section 33 causes relevant information that is externally acquired by the communication control section 24 or the operation acquisition section 25 to be stored, as recorded relevant information, in the recording/reproducing device 1 while registered information is being reproduced by the reproduction control section 21. Thus, the recording/reproducing device 1 can select relevant information for recording from the relevant information thus externally acquired. Further, since the relevant information is externally acquired, new recorded relevant information or updated recorded relevant information can be stored in the recording/reproducing device 1.

Further, according to the recording/reproducing device 1, the recording control section 22 causes file management information indicative of attribute information of the relevant information for recording selected by the data selecting section 31 to be recorded, as recorded information, on the RE layer of the optical disc 100. As a result, the data comparing section 30 is only required to compare, at the time of next insertion of the optical disc 100 into the recording/reproducing device 1, the file management information recorded on the optical disc 100 and recorded relevant information stored in the recording/reproducing device 1. That is, relevant information (relevant information for recording) itself recorded on the RE layer need not to be read out and be compared with the recorded relevant information stored in the recording/reproducing device 1. This makes it possible to provide an optical disc 100 which allows a reduction in processing time required for the comparison after the file management information is recorded.

Further, according to the recording/reproducing device 1, the data comparing section 30 can use, as information to be compared with the recorded relevant information stored in the recording/reproducing device 1, the file management information which is recorded on the RE layer and which is read out by the reproduction control section 21. As a result, the relevant information (relevant information for recording) itself recorded on the RE layer need not to be read out and be compared with the recorded relevant information stored in the recording/reproducing device 1. This allows a reduction in processing time required for the comparison, thereby allowing speedy processing.

Further, according to the recording/reproducing device 1, the data management section 33 deletes the recorded relevant information that has been selected, as relevant information for recording, by the data selecting section 31. This makes it possible to avoid a situation in which the relevant information for recording is used in the recording/reproducing device 1 after ejection of the optical disc 100. That is, the relevant information for recording can be managed only in the optical disc 100. This can prevent the relevant information for recording from being copied, thereby allowing an improvement in security.

This arrangement is especially useful in a case where the storage section 15 is realized by a removable medium such as a USB memory. This is because use of the relevant information for recording in devices other than the recording/reproducing device 1, which is possible in a case where the storage device 15 is realized by a USB memory or the like, can be prevented by deleting the relevant information for recording from the storage section 15.

Note that the deletion of the relevant information for recording from the recording/reproducing device 1 is carried out for example automatically (without user's confirmation) after the relevant information for recording is recorded on the optical disc 100 (or after the optical disc 100 is ejected).

Further, according to the recording/reproducing device 1, the data comparing section 30 carries out the comparing process in a case where the medium type checking section 27 judges that an optical disc inserted into the recording/reproducing device 1 includes the two layers (i.e., in a case where the medium type checking section 27 judges that an optical disc inserted into the recording/reproducing device 1 is the optical disc 100, which is a hybrid disc). Accordingly, even if registered information is recorded on the optical disc 100, the comparing process need not to be carried out in a case where the optical disc 100 has no area on which relevant information for recording related to the registered information can be recorded. That is, it is unnecessary to carry out the processes of the data comparing section 30, the data selecting section 31 etc. in a case where an inserted disc is a disc on which the relevant information for recording cannot be recorded. This can prevent such unnecessary processes from being carried out.

Further, in a case where the above judgment is made, the processes (i.e., selection of relevant information for recording by the data selecting section 31, recording of the relevant information for recording on the optical disc 100 by the recording control section 22, etc.) carried out after the comparing process of the data comparing section 30 are carried out. This makes it possible to prevent relevant information for recording which is related to registered information recorded on a disc from being recorded on another disc. Further, relevant information related to registered information recorded on an optical disc 100 is recorded on the optical disc 100. This eliminates the need for preparing another disc for recording the relevant information, thereby making it possible to make a backup at a low cost.

Further, since relevant information for recording related to registered information is additional information or supplementary information, the recording/reproducing device 1 can surely record the relevant information for recording on an optical disc 100 on which the registered information is recorded.

### Embodiment 2

Another embodiment of the present invention is described below with reference to FIGS. 2 and 6-10. Note that constituents that are similar to those of the Embodiment 1 are given identical reference numerals, and are not explained repeatedly.

[Outline of Recording/Reproducing System 10a]

As illustrated in FIG. 2, a recording/reproducing system 10a of the present embodiment includes a recording/reproducing device 1a, a communication device 2, an operation device 3, and a display device 4. The recording/reproducing system 10a of the present embodiment is similar to the recording/reproducing system of Embodiment 1 except for that the recording/reproducing device 1a is used instead of the recording/reproducing device 1, and therefore is not explained repeatedly. A configuration of the recording/reproducing device 1a is described below.

[Configuration of Recording/Reproducing Device 1a]

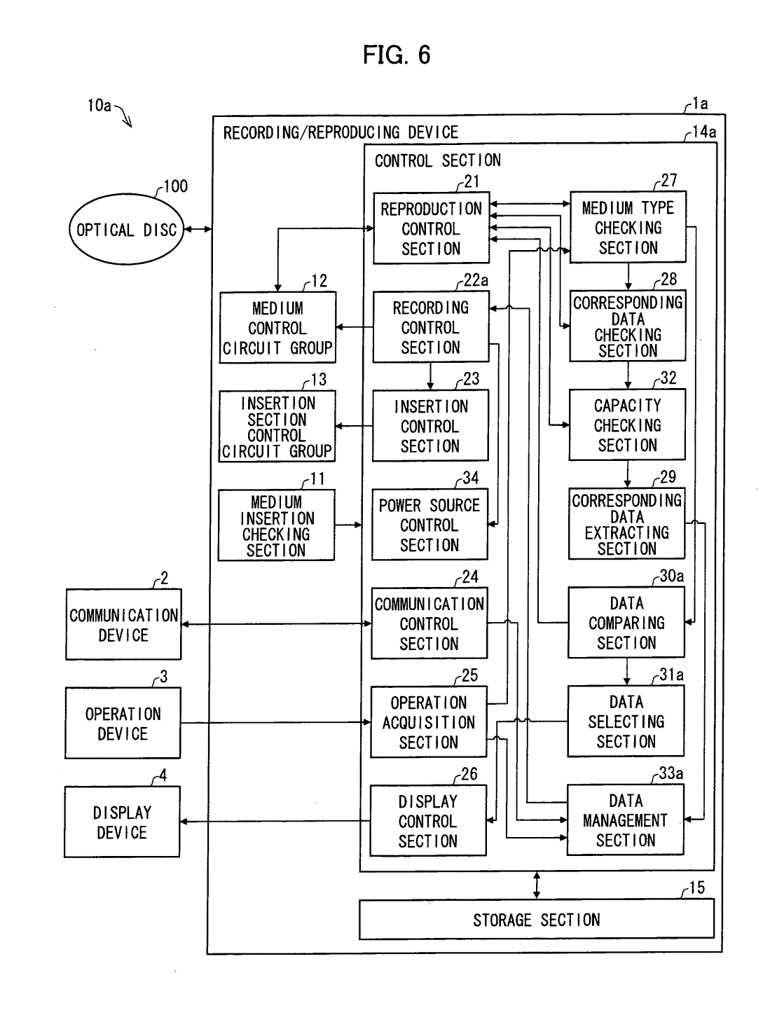

With reference to FIG. 6, the following describes an example of an outline configuration of the recording/reproducing device 1a in the recording/reproducing system 10a of the present embodiment. FIG. 6 is a block diagram illustrating an example of an outline configuration of the recording/reproducing device 1a in the recording/reproducing system 10a of the present embodiment.

As with the recording/reproducing device 1, the recording/reproducing device 1a controls recording/reproducing of information on/from an optical information recording medium such as an optical disc 100 of the present embodiment. The recording/reproducing device 1a is different from the recording/reproducing device 1 in that all the relevant information (corresponding data) stored in the storage section 15 is recorded on the optical disc 100 when reproduction of registered information recorded on the optical disc 100 is stopped, when the recording/reproducing device 1a is turned off or when downloading of relevant information etc. is completed, and then corresponding data which should be recorded (allowed to remain) on the optical disc 100 is selected at the time of ejection of the optical disc 100. In order to realize this processing, the recording/reproducing device 1a includes a medium insertion checking section 11, a medium control circuit group 12, an insertion section control circuit group 13, a control section 14a, and a storage section 15. Note that the constituents other than the control section 14a have similar functions to those of the recording/reproducing device 1, and therefore are not explained repeatedly.

As with the control section 14, the control section 14a controls members constituting the recording/reproducing device 1a, for example, by executing a control program. The control section 14a includes a reproduction control section 21 (reproduction control means), a recording control section 22a (recording control means), an insertion control section 23, a communication control section 24 (acquisition means), an operation acquisition section 25 (acquisition means), a display control section 26, a medium type checking section 27 (medium determining means), a corresponding data checking section 28 (determining means), a corresponding data extracting section 29, a data comparing section 30a (comparing means), a data selecting section 31a (selecting means), a capacity checking section 32, a data management section 33a (update means, storage control means), and a power source control section 34 (power source control means).

Note that the reproduction control section 21, the insertion control section 23, the communication control section 24, the operation acquisition section 25, the display control section 26, the medium type checking section 27, the corresponding data checking section 28, the corresponding data extracting section 29, and the capacity checking section 32 carry out essentially similar processes to those of the Embodiment 1, and therefore are not explained repeatedly.

For example, the reproduction control section 21 controls reproduction of registered information recorded on a ROM layer of the optical disc 100. Each of the communication control section 24 and the operation acquisition section 25 externally acquires relevant information, and the medium type checking section 27 determines whether or not a disc inserted into the recording/reproducing device 1a includes a ROM layer and an RE layer. The corresponding data checking section 28 determines whether or not an individual number for identifying the optical disc 100 which individual number is recorded on the optical disc 100 matches an identification number contained in relevant information stored in the recording/reproducing device 1a.

Examples of the relevant information include an additional content etc. as in the Embodiment 1. In the Embodiment 2, relevant information stored in the storage section 15 and relevant information recorded on the RE layer by the recording control section 22a may be referred to as “recorded relevant information”.

As in the Embodiment 1, the recording control section 22a controls recording of information on an optical information recording medium such as the optical disc 100. In addition, the recording control section 22a causes relevant information stored in the recording/reproducing device 1a to be recorded on the RE layer of the optical disc 100 when reproduction of registered information by the reproduction control section 21 is stopped or when power supply from the power source control section 34 to each section of the recording/reproducing device 1a is stopped. Further, the recording control section 22a causes relevant information stored in the recording/reproducing device 1a by the data management section 33a to be recorded on the RE layer of the optical disc 100 when acquisition of the relevant information (e.g., downloading of the relevant information) by the communication control section 24 or the operation acquisition section 25 is completed.

The recording process of recording the relevant information on the optical disc 100, which is carried out by the recording control section 22a when reproduction of the registered information is stopped, when power supply is stopped or when downloading is completed, is carried out in a case where the corresponding data checking section 28 determines that the individual number (individual identification information) matches the identification number (individual identification information).

Meanwhile, in a case where it is determined that the data management section 33a does not record relevant information for recording, the recording control section 22a deletes additional data or new data which has been judged to be relevant information for recording from the RE layer of the optical disc 100.

The data comparing section 30a compares, at the time of ejection of the optical disc 100, (i) relevant information (recorded relevant information) recorded on the RE layer as information related to registered information recorded on the ROM layer and (ii) file management information indicative of attribute information of relevant information which is present on the RE layer from the time of insertion of the optical disc 100.

Specifically, the data comparing section 30a determines whether or not there is relevant information on the RE layer of the optical disc 100 based on whether or not the reproduction control section 21 reads out relevant information from the optical disc 100. In a case where there is relevant information, the data comparing section 30a checks whether or not there is file management information in a similar manner to the Embodiment 1.

In a case where it is determined that there is file management information in the optical disc 100, the data comparing section 30a checks whether or not attribute information of the file management information includes attribute information that is different from the attribute information of the relevant information stored in the optical disc 100. In a case where it is determined, as a result of the checking, that there is relevant information whose attribute information is different from the relevant information of the file management information, the data comparing section 30a determines that the optical disc 100 contains relevant information that is different from the relevant information which is present on the RE layer from the time of insertion of the optical disc 100 (determines that “there is additional data”). Meanwhile, in a case where it is determined that there is no relevant information whose attribute information is different from the relevant information of the file management information, the data comparing section 30a determines that the relevant information stored in the optical disc 100 is the same as the relevant information which is present from the time of insertion of the optical disc 100 (determines that “there is no additional data”).

Meanwhile, in a case where it is determined that there is no file management information in the optical disc 100, the data comparing section 30a determines that relevant information stored in the optical disc 100 is first data (new data) recorded as relevant information related to registered information of the optical disc 100.

Further, the data comparing section 30a compares (i) the relevant information (recorded relevant information) which is recorded on the optical disc 100 by the recording control section 22a when reproduction of the registered information is stopped, when power supply is stopped or when the downloading is completed and (ii) file management information which is present from the time of insertion of the optical disc 100. This comparison by the data comparing section 30a is carried out in a case where the medium type checking section 27 determines that the optical disc 100 has a ROM layer and an RE layer.

The data selecting section 31a selects the additional data or the new data as relevant information for recording which should be allowed to remain on the RE layer of the optical disc 100 in a case where it is determined that the additional data or the new data is present in the optical disc 100. In other words, the data selecting section 31a selects, based on a result of the comparison by the data comparing section 30a, relevant information for recording which should be allowed to remain on the RE layer from among the relevant information (recorded relevant information).

When the reproduction of the registered information is stopped, when the power supply is stopped or when the downloading is completed, the data management section 33a determines on which position (address information) of the RE layer of the optical disc 100 corresponding data extracted by the corresponding data extracting section 29 is to be recorded, and adds the position to attribute information of the corresponding data. This allows the recording control section 22a to record the corresponding data on a predetermined position of the RE layer of the optical disc 100.

When relevant information is externally acquired during reproduction of the registered information, the data management section 33a assigns, as an identification number, the individual number of the inserted optical disc 100 to attribute information of the relevant information, and then causes the relevant information to which the identification number is assigned to be stored in the storage section 15. In other words, the data management section 33a causes relevant information acquired by the communication control section 24 or the operation acquisition section 25 to be stored in the recording/reproducing device 1a. During this process, the data management section 33a checks whether the acquisition of the relevant information has been completed or not.

Further, in a case where it is determined, as a result of selection by a user, that the relevant information for recording selected by the data selecting section 31a should be recorded, the data management section 33a creates or updates file management information with the use of attribute information of the relevant information for recording which attribute information is stored in the storage section 15. In other words, the data management section 33a updates the file management information with the use of the relevant information for recording selected by the data selecting section 31a. Thus, the recording control section 22a can record this file management information on the optical disc 100.

Meanwhile, in a case where it is determined that the relevant information for recording should not be recorded, the data management section 33a causes the recording control section 22a to delete, from the RE layer of the optical disc 100, the additional data or the new data which has been judged to be the relevant information for recording.

The power source control section 34 controls power supply of the recording/reproducing device 1a. For example, the power source control section 34 stops power supply from a power source (not shown) to each section.

[Process Flow in Recording/Reproducing Device 1a]

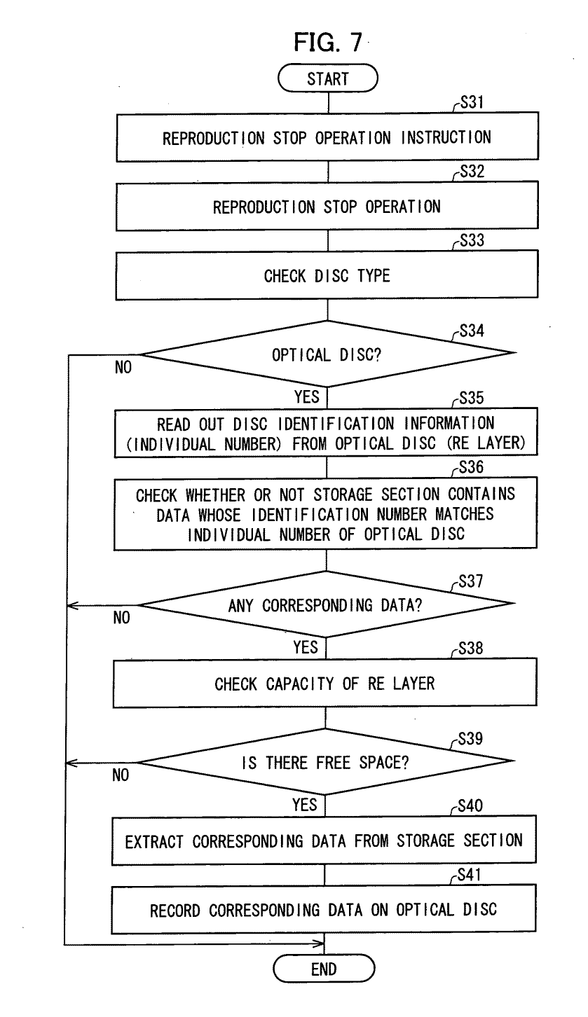

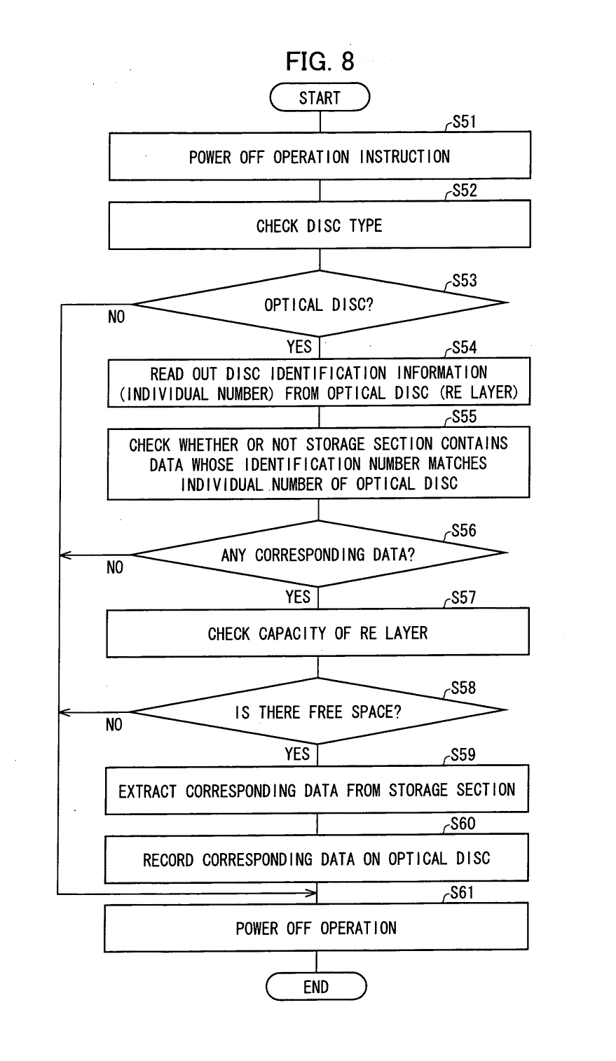

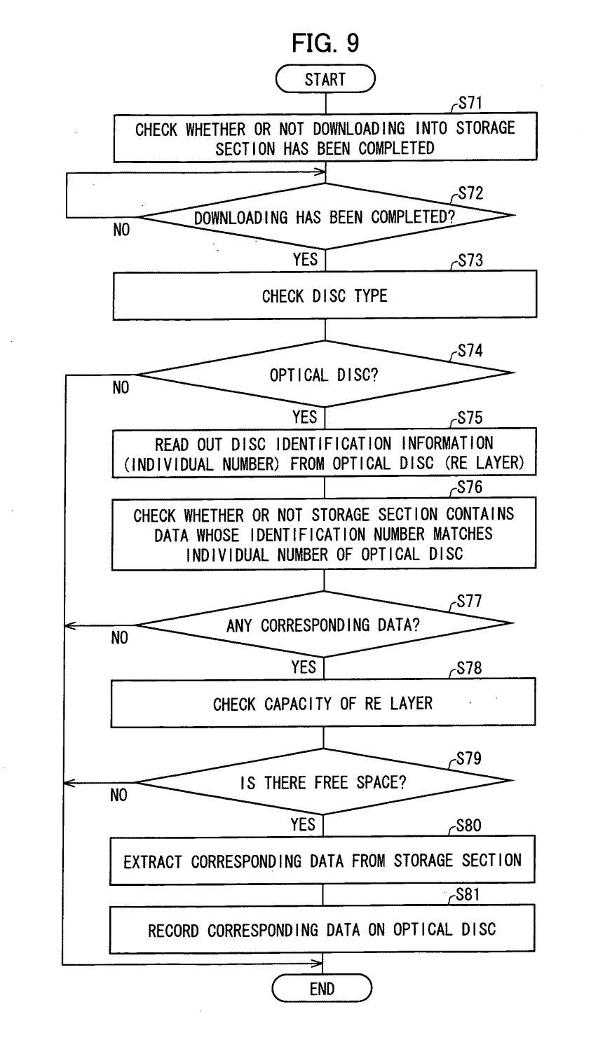

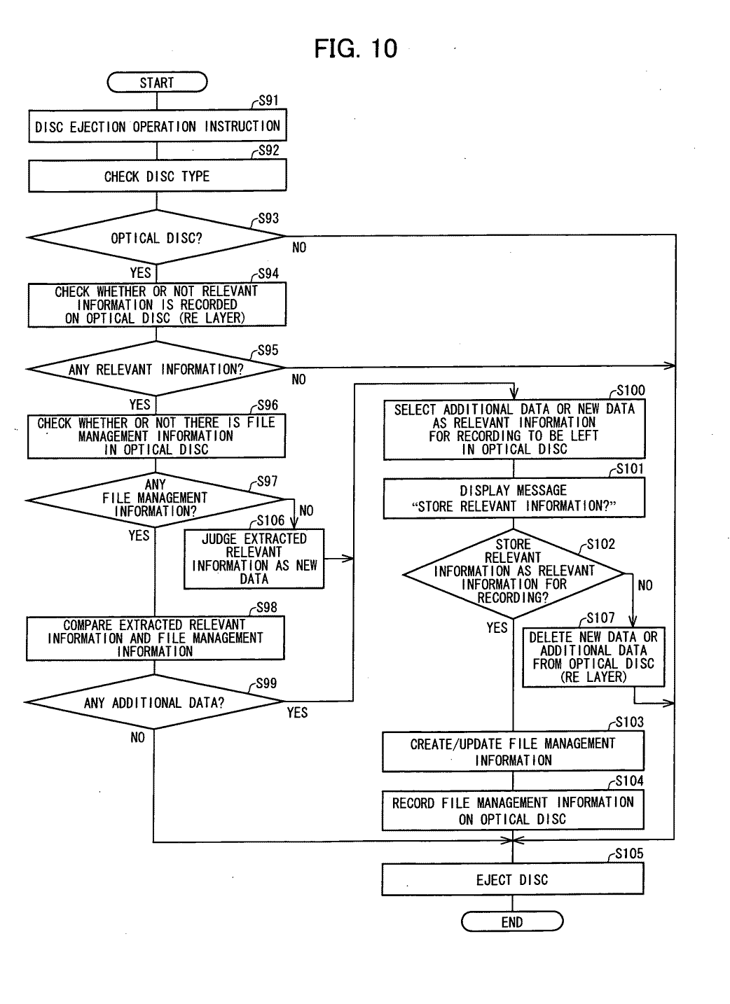

Next, with reference to FIGS. 7 through 10, the following describes a process flow in the recording/reproducing device 1a. Explained first are processing carried out when the reproduction of the registered information recorded on the optical disc 100 is stopped (see FIG. 7), processing carried out when the recording/reproducing device 1a is turned off (see FIG. 8), and processing carried out when downloading of relevant information is completed (see FIG. 9). Explained next with reference to FIG. 10 is processing of selecting relevant information for recording (corresponding data) which should be allowed to remain on the optical disc 100 at the time of ejection of the optical disc 100 from among corresponding data that is recorded on the optical disc 100 in the processes shown in FIGS. 7 through 9. That is, the processing shown in FIG. 10 is carried out after the processing of FIGS. 7 through 9.

It is only necessary that at least one of the processing of FIG. 7, the processing of FIG. 8, and the processing of FIG. 9 be carried out before an instruction to eject the optical disc 100 is given. In a case where more than one of these processing is carried out, the processing may be carried out in any order. It is also possible that the same processing is carried out plural times.

Processes carried out before the processes of FIGS. 7 through 9, i.e., processes carried out after insertion of the optical disc 100, such as reproduction of the registered information, acquisition of relevant information, and assignment of an identification number to the relevant information are similar to those of the Embodiment 1, and therefore are not explained repeatedly.

(Flow of Processes Carried Out when Reproduction of Registered Information is Stopped)

First, with reference to FIG. 7, the following describes the processes carried out when reproduction of the registered information recorded on the inserted optical disc 100 is stopped. FIG. 7 is a flowchart showing an example of a flow of processes carried out in the recording/reproducing device 1a when reproduction of the registered information is stopped.

First, the operation acquisition section 25 acquires an instruction to stop reproduction of the registered information (reproduction stop operation instruction) (S31). For example, when a user inputs an instruction to stop reproduction of the registered information that is being reproduced with the use of the operation device 3, an input signal indicative of the input is transmitted to the operation acquisition section 25.

The operation acquisition section 25 transmits the input signal to the reproduction control section 21. In response to this, the reproduction control section 21 stops reproduction of the registered information, i.e., carries out the reproduction stop operation (S32). After stopping the reproduction of the registered information, the reproduction control section 21 notifies the medium type checking section 27 that the reproduction of the registered information has been stopped.

In response to receipt of this notification, the medium type checking section 27 checks a type of an inserted disc (disc type) (S33). The processes in S33 through S37 are similar to those of S2 through S6 shown in FIG. 5, and therefore are not explained repeatedly.

In a case where it is determined, in S37, that there is data (corresponding data) whose identification number matches an individual number of disc identification information (YES in S37), the corresponding data checking section 28 notifies the capacity checking section 32 that there is corresponding data. In response to receipt of this notification, the capacity checking section 32 checks a free space of the RE layer of the optical disc 100 to confirm whether or not the corresponding data can be recorded on the optical disc 100 (S38). Specifically, the capacity checking section 32 gives the reproduction control section 21 an instruction to read out file management information from the RE layer of the optical disc 100. In response to receipt of this instruction, the reproduction control section reads out the file management information from the optical disc 100, and then transmits the file management information to the capacity checking section 32. The capacity checking section 32 checks, with reference to this file management information, whether or not the optical disc 100 has a free space (S39). Note that the capacity checking section 32 can recognize a full capacity of the RE layer (user data area 103) of the optical disc 100 based on disc identification information (stored in the storage section 15 for example) read out, for example, when the disc type is determined in S33. In a case where the file management information is not received from the reproduction control section 21 within a predetermined period of time, the capacity checking section 32 determines that there is no file management information in the optical disc 100, and therefore determines that an entire space of the RE layer is available.

In a case where it is determined that there is a free space (YES in S39), the capacity checking section 32 notifies the corresponding data extracting section 29 that there is a free space. In response to receipt of this notification, the corresponding data extracting section 29 extracts the corresponding data from the storage section 15, and then transmits the corresponding data to the data management section 33a (S40).

After receiving the corresponding data, the data management section 33a determines on which position of the user data area 103 of the RE layer the corresponding data is to be recorded (determines address information), and adds the position to attribute information of the corresponding data. After determining the position on which the corresponding data is to be recorded, the data management section 33a transmits the corresponding data to the recording control section 22a. The recording control section 22a receives the corresponding data, and then records the corresponding data on the RE layer (the user data area 103) of the optical disc 100 (S41). Thus, the processes shown in FIG. 7 are completed. Also in the case of NO in S34, S37 or S39, the processes shown in FIG. 7 are completed.

(Flow of Processes Carried Out when Recording/Reproducing Device 1a is Turned Off)

Next, with reference to FIG. 8, the following describes a flow of the processes carried out when the recording/reproducing device 1a is turned off. FIG. 8 is a flowchart showing a flow of the processes carried out when the recording/reproducing device 1a is turned off.

First, the operation acquisition section 25 acquires an instruction to turn off the recording/reproducing device 1a (power off operation instruction) (S51). For example, in a case where a user inputs an instruction to turn off the recording/reproducing device 1a (for example by pushing a power button) with the use of the operation device 3, an input signal indicative of the input is transmitted to the operation acquisition section 25.

The operation acquisition section 25 transmits the input signal to the medium type checking section 27. In response to this, the medium type checking section 27 checks a type of an inserted disc (disc type) (S52). The subsequent processes in S52 through S60 are similar to those of S33 through S41 shown in FIG. 7, and therefore are not explained repeatedly.

After receiving, from the data management section 33a, corresponding data whose recorded position has been determined, the recording control section 22a records the corresponding data on the RE layer (the user data area 103) of the optical disc 100 (S60). When the recording of the corresponding data on the optical disc 100 is completed, the recording control section 22a notifies the power source control section 34 of the completion.

In response to receipt of this notification, the power source control section 34 stops power supply from the power source (not shown) to each section (S61). Thus, the processes shown in FIG. 8 are completed.

(Flow of Processes Carried Out when Downloading of Relevant Information is Completed)

Next, with reference to FIG. 9, the following describes a flow of processes carried out in the recording/reproducing device 1a when downloading of relevant information is completed. FIG. 9 is a flowchart showing an example of processes carried out when downloading of relevant information is completed.

First, in a case where the communication control section 24 downloads relevant information, for example, from a content server (or in a case where the operation acquisition section 25 acquires relevant information inputted by a user), the relevant information thus acquired is sequentially transmitted to the data management section 33a. The data management section 33a receives the relevant information, and then causes the relevant information to be stored in the storage section 15. During this process, the data management section 33a is checking whether the downloading of the relevant information has been completed or not (S71). In the case of packet communication for example, the data management section 33a determines, by confirming a flag indicative of a final frame, whether all the relevant information has been received or not, i.e., whether the downloading of the relevant information has been completed or not (S72). Since the reception of the relevant information continues until the downloading is completed, the data management section 33a continues to check whether the downloading has been completed or not in the case of NO in S72.

In a case where it is confirmed that the downloading has been competed (YES in S72), the data management section 33a notifies the medium type checking section 27 of the completion of the downloading. In response to receipt of this notification, the medium type checking section 27 checks a type of an inserted disc (disc type) (S73). The subsequent processes in S73 through S81 are similar to those of S33 through S41 shown in FIG. 7, and therefore are not explained repeatedly.

(Flow of Processes Carried Out when Optical Disc 100 is Ejected)

Next, with reference to FIG. 10, the following describes a flow of processes carried out when the optical disc 100 is ejected. FIG. 10 is a flowchart showing an example of a flow of processes carried out when the optical disc 100 is ejected.

First, the operation acquisition section 25 acquires an instruction to eject an optical disc from an insertion section (not shown) (disc ejection operation instruction) (S91). Subsequent processes in S91 through S93 are similar to those of S1 through S3 shown in FIG. 5, and therefore are not explained repeatedly.

In a case where it is determined, in S93, that an inserted disc is the optical disc 100 (YES in S93), the medium type checking section 27 notifies the data comparing section 30a that the inserted disc is the optical disc 100. In response to receipt of this notification, the data comparing section 30a checks whether or not relevant information (corresponding data) is recorded on the RE layer (the user data area 103) of the optical disc 100 (S94). Specifically, the data comparing section 30a gives the reproduction control section 21 an instruction to read out relevant information from the RE layer of the optical disc 100. In response to receipt of this instruction, the reproduction control section 21 reads out the relevant information in a case where there is relevant information on the user data area 103 of the RE layer, and then transmits the relevant information to the data comparing section 30a. In a case where the data comparing section 30a receives the relevant information, the data comparing section 30a determines that “there is data” in the optical disc 100, whereas in a case where the data comparing section 30a does not receive the relevant information, for example, within a predetermined, period of time from the transmission of the instruction to read out the relevant information, the data comparing section 30a determines that “there is no data” in the optical disc 100 (S95).

In a case where it is determined that there is relevant information in the optical disc 100 (YES in S95), the data comparing section 30a then checks whether or not there is file management information in the optical disc 100 (S96). In this case, by carrying out s similar process to S9 shown in FIG. 5, the data comparing section 30a determines whether or not the file management information is recorded on the RE layer of the optical disc 100 (S97).

In a case where it is determined that there is file management information in the optical disc 100 (YES in S97), the data comparing section 30a compares (i) the relevant information that has been read out in S94 by the reproduction control section 21 (the relevant information extracted from the optical disc 100) and (ii) the file management information that has been read out in S96 by the reproduction control section 21 (S98).

Specifically, the data comparing section 30a compares attribute information of the relevant information and attribute information contained in the file management information so as to check whether or not the attribute information of the file management information contains attribute information that is different from the attribute information of the relevant information. In a case where there is relevant information whose attribute information is different from the attribute information of the file management information, the data comparing section 30a determines that relevant information that is different from the relevant information which is present on the RE layer from the time of insertion of the optical disc 100 is contained in the relevant information that has been read out in S94 by the recording control section 22a (determines that “there is additional data”). Meanwhile, in a case where there is no relevant information whose attribute information is different from the attribute information of the file management information, the data comparing section 30a determines that the relevant information read out in S94 is the same as the relevant information which is present from the time of insertion of the optical disc 100 (determines that “there is no additional data”) (S99). In a case where it is determined that there is additional data (YES in S99), the data comparing section 30a notifies the data selecting section 31a that there is additional data.

Meanwhile, in a case where it is determined that there is no file management information in the optical disc 100 (NO in S97), the data comparing section 30a determines that the relevant information that has been read out (relevant information that has been extracted) in S94 by the reproduction control section 21 is first data (new data) recorded, as relevant information related to registered information of the optical disc 100, on the RE layer (the user data area 103) of the optical disc 100 (S106). Then, the data comparing section 30a notifies the data selecting section 31a that the new data is stored in the storage section 15.

When the data selecting section 31a is notified that there is additional data (YES in S99) or notified, in S106, that there is new data, the data selecting section 31a selects the additional data or the new data as relevant information for recording which should be left (allowed to remain) on the RE layer (the user data area 103) of the optical disc 100 (S100). The data selecting section 31a notifies the display control section 26 that the additional data or the new data has been selected as relevant information for recording.

In response to receipt of this notification, the display control section 26 creates an inquiry image containing a message “STORE RELEVANT INFORMATION?”, and causes the display device 4 to display the inquiry image (S101). After confirming this message, a user inputs a judgment as to whether the additional data is stored or not, to the recording/reproducing device 1a with the use of the operation device 3. In the recording/reproducing device 1a, the operation acquisition section 25 receives this input as an input signal, and then transmits the input signal to the data management section 33a. The data management section 33a analyzes this input signal so as to judge whether or not the relevant information for recording selected by the data selecting section 31a should be left (allowed to remain) (S102).

In a case where it is determined that the relevant information for recording selected by the data selecting section 31a should be allowed to remain (YES in S102), the data management section 33a creates or updates file management information with the use of attribute information of the additional data or the new data which has been judged to be the relevant information for recording which attribute information is stored in the storage section 15 (S103), and then transmits this file management information to the recording control section 22a.

The recording control section 22a receives the file management information, and records the file management information on the RE layer of the optical disc 100 (S104). Then, the recording control section 22a notifies the insertion control section 23 that the file management information has been recorded on the RE layer of the optical disc 100.

Meanwhile, in a case where it is determined that the relevant information for recording selected by the data selecting section 31a should not be recorded (NO in S102), the data management section 33a gives the recording control section 22a an instruction to delete, from the RE layer (the user data area 103) of the optical disc 100, the additional data or the new data which has been judged to be the relevant information for recording.

In response to receipt of this instruction, the recording control section 22a deletes the additional data or the new data from the optical disc 100 (S107). Specifically, the recording control section 22a deletes these data by turning an area where the additional data or the new data is recorded into an area where no data is recorded or by changing the additional data or the new data into utterly different information (meaningless information). After deleting these data, the recording control section 22a notifies the insertion control section 23 of the deletion.

In response to receipt of the notification given after the process in S104 or S107, the insertion control section 23 controls the insertion section control circuit group 13 so that the optical disc 100 inserted into the insertion section is ejected (S105). Thus, the processes shown in FIG. 10 are completed. Also in a case where the insertion control section 23 is notified of NO in S93, S95 or S99, the insertion control section 23 carries out an ejection operation of the optical disc 100 upon receipt, from a corresponding section, of the notification.

Note that another arrangement is possible in which the data management section 33a deletes the additional data or the new data which has been selected in S100 as the relevant information for recording and which is stored in the storage section 15, as in the process of S18 shown in FIG. 5. In this case, the relevant information which has been selected as the relevant information for recording which has been recorded on the optical disc 100 does not remain in the storage section 15 after the ejection of the optical disc 100, as in the Embodiment 1. This makes it possible to prevent the relevant information from being used when another disc is inserted. In this case, it is therefore possible to realize safe management of data.

In the process in S107, the recording control section 22a deletes the additional data or the new data from the optical disc 100, but the present embodiment is not limited to this. Alternatively, another arrangement is possible in which only the address information indicative of the position on which the data is recorded is deleted.

In this case, the data remains in the optical disc 100. However, even if only the address information of a part of a file format which part manages the data (part which manages information as to which file is recorded on which address) is deleted, the file format is seemingly deleted, and the data cannot be read out. That is, only the file management information of the additional data or the new data is deleted from the optical disc 100 and the data itself is not deleted. This makes it possible to more speedily carry out the deletion process. In this case, in a case where identical additional data or new data is recorded again, this data is written over the data which is remaining in the optical disc 100 (data which has been seemingly deleted).

[Effects in Recording/Reproducing Device 1a]

The recording/reproducing device 1a of the present embodiment produces similar effects to the recording/reproducing device 1 of the Embodiment 1, and further produces the following effects.

For example, the recording/reproducing device 1a (method for controlling the recording/reproducing device 1a) includes the data comparing section 30a (comparing step) which compares, at the time of ejection of the optical disc 100, relevant information (recorded relevant information) related to registered information recorded on the ROM layer which relevant information is recorded on the RE layer and file management information indicative of attribute information of recorded relevant information that is present on the RE layer from the time of insertion of the optical disc 100; and the data selecting section 31a (selecting step) which selects, based on a result of the comparison by the data comparing section 30a, relevant information for recording which should be recorded on the RE layer from the recorded relevant information.

According to the arrangement, it is possible to produce the same effect as the Embodiment 1 that information related to registered information recorded in advance on an information recording medium can be easily managed by causing the information to be recorded on the information recording medium without bothering a user.

Further, according to the recording/reproducing device 1a, the data management section 33a updates file management information with the use of relevant information for recording. This allows the processes by the data comparing section 30a and the data selecting section 31a to be carried out with the use of new file management information every time the optical disc 100 is inserted.

Further, according to the recording/reproducing device 1a, when reproduction of registered information by the reproduction control section 21 is stopped, when the recording/reproducing device 1a is turned off by the power source control section 34 or when downloading of relevant information by the communication control section 24 or the operation acquisition section 25 is completed, the recording control section 22a causes recorded relevant information stored in the recording/reproducing device 1a to be recorded on the RE layer of the optical disc 100 on which the registered information related to the recorded relevant information is recorded. Then, the data comparing section 30a compares the recorded relevant information thus recorded on the RE layer and file management information that is recorded on the RE layer.

This allows the recording/reproducing device 1a to record candidates for relevant information for recording, which are judged as information which should be recorded on the RE layer, at least before ejection of the optical disc 100.

Further, according to the recording/reproducing device 1a, the recording control section 22a records recorded relevant information on the RE layer of the optical disc 100 in a case where it is determined that an individual number recorded on the optical disc 100 matches an identification number contained in the recorded relevant information stored in the recording/reproducing device 1a. This makes it possible to surely specify an optical disc 100 on which the recorded relevant information is to be recorded before selecting relevant information for recording to be recorded on the optical disc 100.

Further, according to the recording/reproducing device 1a, the data comparing section 30a carries out the comparing process in a case where the medium type checking section 27 judges that the optical disc 100 inserted into the recording/reproducing device 1a includes the two layers. This makes it possible to prevent unnecessary processes, as in the Embodiment 1.

[Alternative Expression of Present Invention]

The present invention can be also described as follows.

It is preferable that a recording/reproducing device of the present invention includes recording control means for recording the relevant information for recording thus selected by the selecting means on the second information recording layer.

According to the arrangement, the relevant information for recording selected at the time of ejection of the information recording medium can be recorded on the second information recording layer of the information recording medium on which the registered information related to the relevant information for recording is recorded. This allows the relevant information for recording related to the registered information to be surely managed in the information recording medium on which the registered information is recorded without bothering a user.

It is preferable that the recording/reproducing device of the present invention includes determining means for determining whether or not individual identification information for identifying the information recording medium which individual identification information is recorded on the information recording medium matches individual identification information contained in the recorded relevant information, the comparing means comparing the recorded information and the recorded relevant information in a case where the determining means determines that the individual identification information recorded on the information recording medium matches the individual identification information contained in the recorded relevant information.

According to the arrangement, the comparing means compares the recorded information and the recorded relevant information in a case where the determining means determines that the individual identification information recorded on the information recording medium matches the individual identification information contained in the recorded relevant information stored in the recording/reproducing device. This makes it possible to surely specify an information recording medium on which the recorded relevant information should be recorded before selecting the relevant information for recording to be recorded on the information recording medium.

It is preferable that the recording/reproducing device of the present invention includes: reproduction control means for controlling reproduction of the registered information; acquisition means for externally acquiring relevant information as the recorded relevant information during reproduction of the registered information by the reproduction control means; and storage control means for causing the relevant information thus acquired by the acquisition means to be stored, as the recorded relevant information, in the recording/reproducing device.

According to the arrangement, the storage control means causes the relevant information thus externally acquired by the acquisition means to be stored, as the recorded relevant information, in the recording/reproducing device during reproduction of the registered information by the reproduction control means. As such, in the recording/reproducing device, the relevant information for recording can be selected from the relevant information (recorded relevant information) externally acquired. Moreover, according to the recording/reproducing device, since the relevant information is externally acquired as the recorded relevant information, new recorded relevant information or updated relevant information can be stored in the recording/reproducing device.

It is preferable that the recording/reproducing device of the present invention includes recording control means for causing record management information to be recorded, as the recorded information, on the second information recording layer, the record management information being indicative of attribute information of the relevant information for recording selected by the selecting means.

According to the arrangement, the recording control means records, as recorded information, the record management information indicative of attribute information of the relevant information for recording selected by the selecting means. As such, the comparing means is only required to compare, at the time of next insertion of the information recording medium into the recording/reproducing device, the record management information recorded on the information recording medium and recorded relevant information stored in the recording/reproducing device. That is, relevant information (relevant information for recording) itself recorded on the second information recording layer need not to be read out and be compared with the recorded relevant information stored in the recording/reproducing device. This makes it possible to provide an information recording medium which allows a reduction in processing time required for the comparison after the record management information is recorded.

It is preferable that the recording/reproducing device of the present invention includes reproduction control means for reading out record management information recorded on the second information recording layer, the comparing means comparing the record management information thus read out by the reproduction control means and the recorded relevant information stored in the recording/reproducing device.

According to the arrangement, the comparing means can use, as information to be compared with the recorded relevant information stored in the recording/reproducing device, the record management information which is recorded on the second information recording layer and which is read out by the reproduction control means. As a result, the information (relevant information for recording) itself recorded on the second information recording layer need not to be read out and be compared with the recorded relevant information stored in the recording/reproducing device. This allows a reduction in processing time required for the comparison, thereby allowing speedy processing.

It is preferable that the recording/reproducing device of the present invention includes deleting means for deleting, from the recording/reproducing device, recorded relevant information selected as the relevant information for recording by the selecting means.

According to the arrangement, the deleting means deletes the recorded relevant information that has been selected, as relevant information for recording, by the selecting means. This makes it possible to avoid a situation in which the relevant information for recording is used in the recording/reproducing device after ejection of the information recording medium. That is, the relevant information for recording can be managed only in the information recording medium. This allows an improvement in security.

It is preferable that the recording/reproducing device of the present invention includes medium determining means for determining whether or not an information recording medium inserted into the recording/reproducing device includes the first information recording layer and the second information recording layer,

the comparing means comparing the recorded information and the recorded relevant information in a case where the medium determining means determines that the information recording medium includes the first information recording layer and the second information recording layer. According to the arrangement, the comparing means carries out the comparing process in a case where the medium determining means judges that an information recording medium inserted into the recording/reproducing device includes the two layers. Accordingly, even if registered information is recorded on the information recording medium, the comparing process need not to be carried out in a case where the information recording medium has no area on which relevant information for recording related to the registered information can be recorded. That is, it is unnecessary to carry out the processes of the comparing means, the selecting means etc. in a case where an inserted information recording medium is an information recording medium on which the relevant information for recording cannot be recorded. This can prevent such unnecessary processes from being carried out.

It is preferable that the recording/reproducing device of the present invention includes updating means for updating the record management information with use of the relevant information for recording selected by the selecting means.

According to the arrangement, the updating means updates record management information with the use of relevant information for recording. This allows the processes by the comparing means and the selecting means to be carried out with the use of new record management information every time the information recording medium is inserted.

It is preferable that the recording/reproducing device of the present invention includes reproduction control means for controlling reproduction of the registered information; and recording control means for recording, when the reproduction of the registered information by the reproduction control means is stopped, recorded relevant information stored in the recording/reproducing device on the second information recording layer, the comparing means comparing the recorded relevant information thus recorded by the recording control means and the record management information.

According to the arrangement, the recording control means records, when the reproduction of the registered information by the reproduction control means is stopped, recorded relevant information stored in the recording/reproducing device on the second information recording layer of the information recording medium on which the registered information related to the recorded relevant information is recorded. Then, the comparing means compares the recorded relevant information thus recorded on the second information recording layer and record management information recorded on the second information recording layer.

This allows the recording/reproducing device to record candidates for relevant information for recording, which are judged as information which should be recorded on the second information recording layer, at least before ejection of the information recording medium.

It is preferable that the recording/reproducing device of the present invention includes: power source control means for controlling power supply of the recording/reproducing device; and recording control means for recording, when the power supply by the power source control means is stopped, recorded relevant information stored in the recording/reproducing device on the second information recording layer, the comparing means comparing the recorded relevant information thus recorded by the recording control means and the record management information.

According to the arrangement, the recording control means records, when the power supply by the power source control means is stopped, recorded relevant information stored in the recording/reproducing device on the second information recording layer of the information recording medium on which the registered information related to the recorded relevant information is recorded. The comparing means compares the recorded relevant information thus recorded on the second information recording layer and the record management information that is recorded on the second information recording layer.

This allows the recording/reproducing device to record candidates for relevant information for recording, which are judged as information which should be recorded on the second information recording layer, at least before ejection of the information recording medium.

It is preferable that the recording/reproducing device of the present invention includes: acquisition means for externally acquiring relevant information as the recorded relevant information; storage control means for causing the relevant information thus acquired by the acquisition means to be stored, as the recorded relevant information, in the recording/reproducing device; and recording control means for recording, when the acquisition of the relevant information by the acquisition means is completed, the recorded relevant information thus stored in the recording/reproducing device by the storage control means on the second information recording layer, the comparing means comparing the recorded relevant information thus recorded by the recording control means and the record management information.

According to the arrangement, the storage control means causes the relevant information thus externally acquired by the acquisition means to be stored, as recorded relevant information, in the recording/reproducing device. When the acquisition of the relevant information by the acquisition means is completed, the recorded relevant information thus stored in the recording/reproducing device by the storage control means is recorded on the second information recording layer of the information recording medium on which the registered information related to the recorded relevant information is recorded. The comparing means compares the recorded relevant information thus recorded on the second information recording layer and the record management information that is recorded on the second information recording layer.

This allows the recording/reproducing device to record candidates for relevant information for recording, which are judged as information which should be recorded on the second information recording layer, at least before ejection of the information recording medium.

It is preferable that the recording/reproducing device of the present invention includes: determining means for determining whether or not individual identification information for identifying the information recording medium which individual identification information is recorded on the information recording medium matches individual identification information contained in the recorded relevant information stored in the recording/reproducing device, the recording control means recording the recorded relevant information stored in the recording/reproducing device on the second information recording layer in a case where the determining means determines that the individual identification information recorded on the information recording medium matches the individual identification information contained in the recorded relevant information stored in the recording/reproducing device.

According to the arrangement, the recording control means records the recorded relevant information stored in the recording/reproducing device on the second information recording layer in a case where the determining means determines that the individual identification information recorded on the information recording medium matches the individual identification information contained in the recorded relevant information stored in the recording/reproducing device. As such, relevant information for recording to be recorded on the information recording medium can be selected after the information recording medium on which the recorded relevant information is to be recorded is surely specified

It is preferable that the recording/reproducing device of the present invention includes: medium determining means for determining whether or not an information recording medium inserted into the recording/reproducing device includes the first information recording layer and the second information recording layer, the comparing means comparing the recorded relevant information and the record management information in a case where the medium determining means determines that the information recording medium includes the first information recording layer and the second information recording layer.

According to the arrangement, the comparing means carries out the comparing process in a case where the medium determining means determines that the information recording medium inserted into the recording/reproducing device includes the first information recording layer and the second information recording layer. Accordingly, even if registered information is recorded on the information recording medium, the comparing process need not to be carried out in a case where the information recording medium has no area on which recorded relevant information related to the registered information can be recorded. That is, it is unnecessary to carry out the processes of the comparing means, the selecting means etc. in a case where an inserted information recording medium is an information recording medium on which the recorded relevant information cannot be recorded. This can prevent such unnecessary processes from being carried out.

It is preferable that, in the recording/reproducing device of the present invention, the recorded relevant information is additional information or supplementary information that is related to the registered information.

According to the arrangement, additional information or supplementary information related to the registered information can be surely recorded (allowed to remain) on the information recording medium on which the registered information is recorded.

A recording/reproducing device of the present invention which records/reproduces information on/from a multi-layer optical information recording medium including at least one recordable/reproducible layer and at least one reproduction-only layer includes a local memory for storing specific information, and compares, in response to an instruction to eject the optical information recording medium, the specific information stored in the local memory and information recorded on the recordable/reproducible layer of the optical information recording medium.

Further, it is preferable that the recording/reproducing device of the present invention is arranged such that the specific information stored in the local memory is additional information or supplementary information related to a content recorded on the reproduction-only layer.

Further, it is preferable that the recording/reproducing device of the present invention includes means for determining whether or not an identification number contained in the specific information stored in the local memory matches an identification number recorded on the reproduction-only layer.

Further, it is preferable that the recording/reproducing device of the present invention includes means for acquiring the specific information during reproduction of the reproduction-only layer of the optical information recording medium and storing the specific information in the local memory.

Further, it is preferable that the recording/reproducing device of the present invention records record management information on the recordable/reproducible layer of the recording medium after recording the specific information on the recordable/reproducible layer.

Further, it is preferable that the recording/reproducing device of the present invention includes means for reading out the record management information recorded on the recordable/reproducible layer of the recording medium, and determining, based on the record management information, whether the specific information to be recorded has been already recorded or not.

Further, it is preferable that the recording/reproducing device of the present invention includes means for deleting the specific information from the local memory after the optical information recording medium is ejected.

Further, it is preferable that the recording/reproducing device of the present invention records the specific information on the recordable/reproducible layer of the optical information recording medium after reception of an instruction to eject the recording medium.

Further, it is preferable that the recording/reproducing device of the present invention records the specific information on the recordable/reproducible layer of the optical information recording medium after reception of an instruction to stop reproduction of the recording medium.

Further, it is preferable that the recording/reproducing device of the present invention records the specific information on the recordable/reproducible layer of the optical information recording medium after reception of an instruction to stop power supply of the recording/reproducing device.

Further, it is preferable that the recording/reproducing device of the present invention records the specific information on the recordable/reproducible layer of the optical information recording medium after reception of an instruction indicating completion of acquisition of the specific information.

A method of the present invention for storing information of a local memory of a recording/reproducing device which records/reproduces information on/from a multi-layer optical information recording medium including at least one recordable/reproducible layer and at least one reproduction-only layer and which includes a local memory for storing specific information, includes: first means for receiving an ejection signal for ejecting the optical information recording medium; second means for determining, in response to the ejection signal, a type of the optical information recording medium on which information is to be stored, means for recognizing data recorded on the recordable/reproducible layer of the optical information recording medium; means for recognizing the specific information recorded on the local memory; means for comparing results thus recognized; and means for recording only difference data extracted as a result of the comparison.

Further, it is preferable that the method of the present invention for storing information of a local memory includes: means for reading out an individual identification number of the optical information recording medium; means for reading out an identification number from the specific information; and means for determining whether or not the individual identification number of the optical information recording medium matches the identification number read out from the specific information.

Further, it is preferable that the method of the present invention for storing information of a local memory includes seventh means for recording, after recording of the specific information stored in the local memory on the recordable/reproducible layer, record management information indicating that the specific information has been recorded on the recordable/reproducible layer of the optical information recording medium.

Further, it is preferable that the method of the present invention for storing information of a local memory includes eighth means for determining whether or not the specific information to be recorded is present or not, with reference to the record management information indicating that the specific information has been recorded on the recordable/reproducible layer of the optical information recording medium.

Further, it is preferable that the method of the present invention for storing information of a local memory includes ninth means for deleting the information in the local memory before ejection of the optical information recording medium.

[Supplement]

Finally, the blocks of the recording/reproducing devices 1 and 1a, especially the reproduction control section 21, recording control section 22, recording control section 22a, insertion control section 23, communication control section 24, operation acquisition section 25, display control section 26, medium type checking section 27, corresponding data checking section 28, corresponding data extracting section 29, data comparing section 30, data comparing section 30a, data selecting section 31, data selecting section 31a, capacity checking section 32, data management section 33, data management section 33a, and power source control section 34, each of which is included in the control section 14 or 14a, may be realized by way of hardware or software as executed by a CPU as follows:

The recording/reproducing devices 1 and 1a each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the recording/reproducing devices 1 and 1a a computer-readable storage medium containing control program code (executable program, intermediate code program, or source program) for the recording/reproducing devices 1 and 1a, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The recording/reproducing devices 1 and 1a may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a computer data signal embedded in a carrier wave in which the program code is embodied electronically.

The present invention is not limited to the description of the embodiments above, but may be altered by a skilled person within the scope of the claims. An embodiment based on a proper combination of technical means disclosed in different embodiments is encompassed in the technical scope of the present invention.

For example, the display control section 26 causes the display device 4 to display an inquiry image in the process of S101 of FIG. 10, but is not limited to this. The display control section 26 may cause the display device 4 to display the inquiry image in every process in which a user can make a selection. In this case, the display control section 26 causes the display section 4 to display an inquiry image for inquiring of a user whether information is recorded (deleted) or not, for example, in the processes of S15 and S17 of FIG. 5, S41 of FIG. 7, S60 of FIG. 80, S81 of FIG. 9, and S104 of FIG. 10 for recording information on the optical disc 100 and in the processes of S18 of FIG. 5 for deleting information from the storage section 15.

Further, the recording/reproducing devices 1 and 1a each use file management information, but are not limited to this. The recording/reproducing devices 1 and 1a each may use index information. The index information refers to information for collectively managing indexes assigned to respective data recorded on the RE layer of the optical disc 100. That is, any information which is smaller in volume than data itself read out from the RE layer of the optical disc 100 can be used.

### INDUSTRIAL APPLICABILITY

The present invention allows information related to registered information, such as content, recorded in advance in an information recording medium to be easily managed without bothering a user by recording the information on the information recording medium. As such, the present invention can be suitably applied especially to a recording/reproducing device, a recording device (recorder), and a reproducing device (player) for hybrid discs.

### REFERENCE SIGNS LIST

1, 1a: Recording/reproducing device
21: Reproduction control section (reproduction control means)
22, 22a: Recording control section (recording control means)
24: Communication control section (acquisition means)
25: Operation acquisition section (acquisition means)
27: Medium type checking section (medium determining means)
28: Corresponding data checking section (determining means)
30, 30a: Data comparing section (comparing means)
31, 31a: Data selecting section (selecting means)
33: Data management section (storage control means, deleting means)
33a: Data management section (updating means, storage control means)
34: Power source control section (Power source control means)

1. A recording/reproducing device which records/reproduces information on/from an information recording medium which includes a first information recording layer which only allows information to be read out and a second information recording layer which allows information to be additionally recorded or to be rewritten, comprising:
comparing means for comparing, at a time of ejection of the information recording medium, recorded information which is recorded on the second information recording layer and recorded relevant information which is stored in the recording/reproducing device and which is related to registered information recorded on the first information recording layer; and
selecting means for selecting, based on a result of the comparison by the comparing means, relevant information for recording, which is information to be recorded on the second information recording layer, from among the recorded relevant information.

2. The recording/reproducing device according to claim 1, further comprising recording control means for recording the relevant information for recording thus selected by the selecting means on the second information recording layer.

3. The recording/reproducing device according to claim 1, further comprising:
determining means for determining whether or not individual identification information for identifying the information recording medium which individual identification information is recorded on the information recording medium matches individual identification information contained in the recorded relevant information,
the comparing means comparing the recorded information and the recorded relevant information in a case where the determining means determines that the individual identification information recorded on the information recording medium matches the individual identification information contained in the recorded relevant information.

4. The recording/reproducing device according to claim 1, further comprising:
reproduction control means for controlling reproduction of the registered information;
acquisition means for externally acquiring relevant information as the recorded relevant information during reproduction of the registered information by the reproduction control means; and
storage control means for causing the relevant information thus acquired by the acquisition means to be stored, as the recorded relevant information, in the recording/reproducing device.

5. The recording/reproducing device according to claim 1, further comprising:
recording control means for causing record management information to be recorded, as the recorded information, on the second information recording layer, the record management information being indicative of attribute information of the relevant information for recording selected by the selecting means.

6. The recording/reproducing device according to claim 1, further comprising:
reproduction control means for reading out record management information recorded on the second information recording layer,
the comparing means comparing the record management information thus read out by the reproduction control means and the recorded relevant information stored in the recording/reproducing device.

7. The recording/reproducing device according to claim 1, further comprising:
deleting means for deleting, from the recording/reproducing device, recorded relevant information selected as the relevant information for recording by the selecting means.

8. The recording/reproducing device according to claim 1, further comprising:
medium determining means for determining whether or not an information recording medium inserted into the recording/reproducing device includes the first information recording layer and the second information recording layer,
the comparing means comparing the recorded information and the recorded relevant information in a case where the medium determining means determines that the information recording medium includes the first information recording layer and the second information recording layer.

9. A recording/reproducing device which records/reproduces information on/from an information recording medium which includes a first information recording layer which only allows information to be read out and a second information recording layer which allows information to be additionally recorded or to be rewritten, comprising:
comparing means for comparing, at a time of ejection of the information recording medium, (i) recorded relevant information which is recorded on the second information recording layer as information related to registered information recorded on the first information recording layer and (ii) record management information indicative of attribute information of recorded relevant information which is present in the second information recording layer from a time of insertion of the information recording medium; and
selecting means for selecting, based on a result of the comparison by the comparing means, relevant information for recording, which is information to be recorded on the second information recording layer, from among the recorded relevant information which is recorded on the second information recording layer as the information related to the registered information recorded on the first information recording layer.

10. The recording/reproducing device according to claim 9, further comprising updating means for updating the record management information with use of the relevant information for recording selected by the selecting means.

11. The recording/reproducing device according to claim 9, further comprising:
reproduction control means for controlling reproduction of the registered information; and
recording control means for recording, when the reproduction of the registered information by the reproduction control means is stopped, recorded relevant information stored in the recording/reproducing device on the second information recording layer,
the comparing means comparing the recorded relevant information thus recorded by the recording control means and the record management information.

12. The recording/reproducing device according to claim 9, further comprising:
power source control means for controlling power supply of the recording/reproducing device; and
recording control means for recording, when the power supply by the power source control means is stopped, recorded relevant information stored in the recording/reproducing device on the second information recording layer,
the comparing means comparing the recorded relevant information thus recorded by the recording control means and the record management information.

13. The recording/reproducing device according to claim 9, further comprising:
acquisition means for externally acquiring relevant information as the recorded relevant information;
storage control means for causing the relevant information thus acquired by the acquisition means to be stored, as the recorded relevant information, in the recording/reproducing device; and
recording control means for recording, when the acquisition of the relevant information by the acquisition means is completed, the recorded relevant information thus stored in the recording/reproducing device by the storage control means on the second information recording layer,
the comparing means comparing the recorded relevant information thus recorded by the recording control means and the record management information.

14. The recording/reproducing device according to claim 11, further comprising:
determining means for determining whether or not individual identification information for identifying the information recording medium which individual identification information is recorded on the information recording medium matches individual identification information contained in the recorded relevant information stored in the recording/reproducing device,
the recording control means recording the recorded relevant information stored in the recording/reproducing device on the second information recording layer in a case where the determining means determines that the individual identification information recorded on the information recording medium matches the individual identification information contained in the recorded relevant information stored in the recording/reproducing device.

15. The recording/reproducing device according to claim 9, further comprising:
medium determining means for determining whether or not an information recording medium inserted into the recording/reproducing device includes the first information recording layer and the second information recording layer,
the comparing means comparing the recorded relevant information and the record management information in a case where the medium determining means determines that the information recording medium includes the first information recording layer and the second information recording layer.

16. The recording/reproducing device according to claim 1, wherein the recorded relevant information is additional information or supplementary information that is related to the registered information.

17. A method for controlling a recording/reproducing device which records/reproduces information on/from an information recording medium which includes a first information recording layer which only allows information to be read out and a second information recording layer which allows information to be additionally recorded or to be rewritten, comprising the steps of:
(a) comparing, at a time of ejection of the information recording medium, recorded information which is recorded on the second information recording layer and recorded relevant information which is stored in the recording/reproducing device and which is related to registered information recorded on the first information recording layer; and
(b) selecting, based on a result of the comparison in the step (a), relevant information for recording, which is information to be recorded on the second information recording layer, from among the recorded relevant information.

18. A method for controlling a recording/reproducing device which records/reproduces information on/from an information recording medium which includes a first information recording layer which only allows information to be read out and a second information recording layer which allows information to be additionally recorded or to be rewritten, comprising the steps of:
(a) comparing, at a time of ejection of the information recording medium, (i) recorded relevant information which is recorded on the second information recording layer as information related to registered information recorded on the first information recording layer and (ii) record management information indicative of attribute information of recorded relevant information which is present in the second information recording layer from a time of insertion of the information recording medium; and
(b) selecting, based on a result of the comparison in the step (a), relevant information for recording, which is information to be recorded on the second information recording layer, from among the recorded relevant information which is recorded on the second information recording layer as the information related to the registered information recorded on the first information recording layer.
